(19) United States
(12) Patent Application Publication
(10) Pub. No.: US 2014/0125754 A1
(43) Pub. Date: May 8, 2014

(54) WEB PORTAL FOR MANAGING PREMISE SECURITY

(71) Applicant: Helen Haywood, Haddiscoe, Norwich (UK)

(72) Inventor: Helen Haywood, Haddiscoe, Norwich (UK)

(21) Appl. No.: 14/154,096

(22) Filed: Jan. 13, 2014

Related U.S. Application Data
(63) Continuation-in-part of application No. 13/648,202, filed on Oct. 9, 2012, now Pat. No. 8,653,969.
Application No. 13/648,202 is a continuation of application No. 12/281,962, filed on Sep. 5, 2008, now Pat. No. 8,294,574.
(60) Provisional application No. 61/751,546, filed on Jan. 11, 2013.

(30) Foreign Application Priority Data
Mar. 7, 2006 (GB) 0604559.5
Mar. 7, 2007 (GB) PCT/GB07/00795

(51) Int. Cl. H04N 7/18

(52) U.S. Cl. CPC H04N 7/186
USPC 348/14.02; 348/143

(57) ABSTRACT

Premise data of a security event may be received over a first network. The premise data may be captured by a secure gatekeeper adapted to monitor premises. Media may be received over the first network for display on the secure gatekeeper. The media may be provided to the secure gatekeeper. The secure gatekeeper may be instructed over the first network to display the media.

### CROSS-REFERENCE TO RELATED APPLICATIONS

This application is a continuation-in-part application of U.S. application Ser. No. 13/648,202, filed Oct. 9, 2012, entitled “HOME SECURITY SYSTEM;” which is a continuation application of U.S. Ser. No. 12/281,962, filed Sep. 5, 2008, entitled “SECURITY DEVICE COMPRISING A PLURALITY OF INTERFACES,” now U.S. Pat. No. 8,294,574; which claims priority to PCT/GB2007/000795, filed Mar. 7, 2007, entitled “A SECURITY DEVICE COMPRISING A PLURALITY OF INTERFACES;” which claims priority to U.K. Patent Application No. 0604559.5, filed Mar. 7, 2006, entitled “A SECURITY DEVICE COMPRISING A PLURALITY OF INTERFACES, all of which are incorporated herein by reference. This application also claims priority under 35 U.S.C. section 119, to provisional U.S. Application No. 61/751,546, filed Jan. 11, 2013, entitled “WEB PORTAL,” which is hereby incorporated by reference.

### BACKGROUND

In many intercom systems, a person seeking to access premises presses a button to ring a buzzer. The button may alert an occupant of the building to the person's presence. The occupant may release a lock, such as an electronic lock, to allow the person to enter the premises. Some intercom systems may also incorporate cameras, sound monitoring devices, and other devices to provide the occupant with other information related to a person at the entrance of the premises.

Typical intercom systems present many problems for occupants and visitors alike. One problem may arise when the occupant is not home or is vulnerable. For instance, when the occupant is not on the premises, a visitor may be alerted to that fact, and may seek to enter the premises in an unauthorized manner. Moreover, if the visitor sees a vulnerable person (e.g., an elderly person or a child) on the premises through an intercom, the visitor may attempt to enter the building to take advantage of the occupant's vulnerability.

Many intercoms use a land-line or are hardwired into the electric or telecommunications infrastructure of premises. As can be imagined, these intercoms may present problems if visitors disable the intercom by cutting the land-line or wires connected to the intercom. Further, many intercoms that include a camera may be difficult to monitor on a 24 hour basis. The resulting expenses of installation, monitoring, and maintenance are often far from desirable. The resulting systems are often difficult to manage. Cutting connections in resulting systems can prove fatal and can fundamentally undermine security.

### SUMMARY

A method can include: receiving, over a first network, premise data of a security event, the premise data captured by a secure gatekeeper, and the secure gatekeeper adapted to monitor premises; receiving, over the first network, media adapted for display on the secure gatekeeper; providing, over the first network, the media to the secure gatekeeper; instructing, over the first network, the secure gatekeeper to display the media.

In an implementation, the secure gatekeeper comprises an internal device coupled to the first network, and an external device coupled to the first network, the internal device located in a secure area of the premises, and the external device located in an unsecure area of the premises. The external device may be adapted to capture the premise data of the security event. The internal device may be configured to capture the media adapted for display on the secure gatekeeper.

In various implementations, a computer system coupled to the first network is configured to capture the media adapted for display on the secure gatekeeper. The media may be captured on a web browser of the computer system. The media may be captured on a native application of the computer system. The media may be captured on a native application of the computer system, and the computer system comprises a mobile device.

In some implementations, the media comprises one or more images, one or more sounds, or one or more videos of a person managing the premises. The media may comprise a live stream of images, one or more sounds, or one or more videos of a person managing the premises. The live stream may be captured on a web browser of a mobile device. The live stream may be captured on a native application of a mobile device. The live stream may be captured on an internal device of the secure gatekeeper, the internal device located in a secure area of the premises.

In various implementations, the secure gatekeeper is integrated into an Intercom system coupled to the first network. The secure gatekeeper may comprise a doorbell, a control engine, a camera, and an Infrared sensor.

In some implementations, the first network comprises a cellular network. The cellular network may provide cellular data and a cellular voice link to the secure gatekeeper.

In some implementations, the security event comprises a moving object near the secure gatekeeper. The moving object may comprise a person.

In various implementations, the method may further comprise: receiving, over the first network, a notification of the security event from the secure gatekeeper; instructing the secure gatekeeper to capture the premise data, the instructing being in response to the notification of the security event. The notification may comprise a signal indicating a moving object, the signal being from a motion sensor on the secure gatekeeper. The notification may comprise a signal indicating a moving object, the signal being from a heat sensor on the secure gatekeeper.

In some implementations, the method comprises: receiving, over the first network, instructions to manage the secure gatekeeper; managing the secure gatekeeper in accordance with the instructions. In various implementations, the method comprises receiving, over the first network, instructions to manage a premise appliance; managing the premise appliance in accordance with the instructions.

A system can include: an external device management engine coupled to a first network; and a premise security management device management engine coupled to the first network. In operation, premise security management device management engine receives, over the first network, media adapted for display on a secure gatekeeper; the external device management engine: receives, over the first network, premise data of a security event, the premise data captured by a secure gatekeeper, and the secure gatekeeper adapted to monitor premises; provides, over the first network, the media to the secure gatekeeper; instructs, over the first network, the secure gatekeeper to display the media.

In an implementation, the secure gatekeeper comprises an internal device coupled to the first network, and an external device coupled to the first network, the internal device located in a secure area of the premises, and the external device located in an unsecure area of the premises. The external device may be adapted to capture the premise data of the security event. The internal device may be configured to capture the media adapted for display on the secure gatekeeper.

In various implementations, a computer system coupled to the first network is configured to capture the media adapted for display on the secure gatekeeper. The media may be captured on a web browser of the computer system. The media may be captured on a native application of the computer system. The media may be captured on a native application of the computer system, and the computer system comprises a mobile device.

In some implementations, the media comprises one or more images, one or more sounds, or one or more videos of a person managing the premises. The media may comprise a live stream of images, one or more sounds, or one or more videos of a person managing the premises. The live stream may be captured on a web browser of a mobile device. The live stream may be captured on a native application of a mobile device. The live stream may be captured on an internal device of the secure gatekeeper, the internal device located in a secure area of the premises.

In various implementations, the secure gatekeeper is integrated into an Intercom system coupled to the first network. The secure gatekeeper may comprise a doorbell, a control engine, a camera, and an Infrared sensor.

In some implementations, the first network comprises a cellular network. The cellular network may provide cellular data and a cellular voice link to the secure gatekeeper.

In some implementations, the security event comprises a moving object near the secure gatekeeper. The moving object may comprise a person.

In various implementations, the system may further comprise: the external device management engine comprises an event information gathering engine and an external device configuration engine. In operation, the external device management engine receives, over the first network, a notification of the security event from the secure gatekeeper; the external device configuration engine instructs the secure gatekeeper to capture the premise data, the instructing being in response to the notification of the security event. The notification may comprise a signal indicating a moving object, the signal being from a motion sensor on the secure gatekeeper. The notification may comprise a signal indicating a moving object, the signal being from a heat sensor on the secure gatekeeper.

In some implementations, external device management engine may: receive, over the first network, instructions to manage the secure gatekeeper; manage the secure gatekeeper in accordance with the instructions.

In an implementation, the system further comprises a premise appliance management engine, wherein in operation, the premise appliance management engine: receives, over the first network, instructions to manage a premise appliance; manages the premise appliance in accordance with the instructions.

A system may include: means for receiving, over a first network, premise data of a security event, the premise data captured by a secure gatekeeper, and the secure gatekeeper adapted to monitor premises; means for receiving, over the first network, media adapted for display on the secure gatekeeper; means for providing, over the first network, the media to the secure gatekeeper; means for instructing, over the first network, the secure gatekeeper to display the media.

### BRIEF DESCRIPTION OF THE DRAWINGS

FIG. 1 depicts an example of a partially exploded perspective view of a remote unit.

FIG. 2 depicts an example of a partially exploded perspective view of a base unit.

FIG. 3 depicts an example of a flowchart of a method indicating potential modes of operation of the security device, with the device set to “AWAY FROM HOME.”

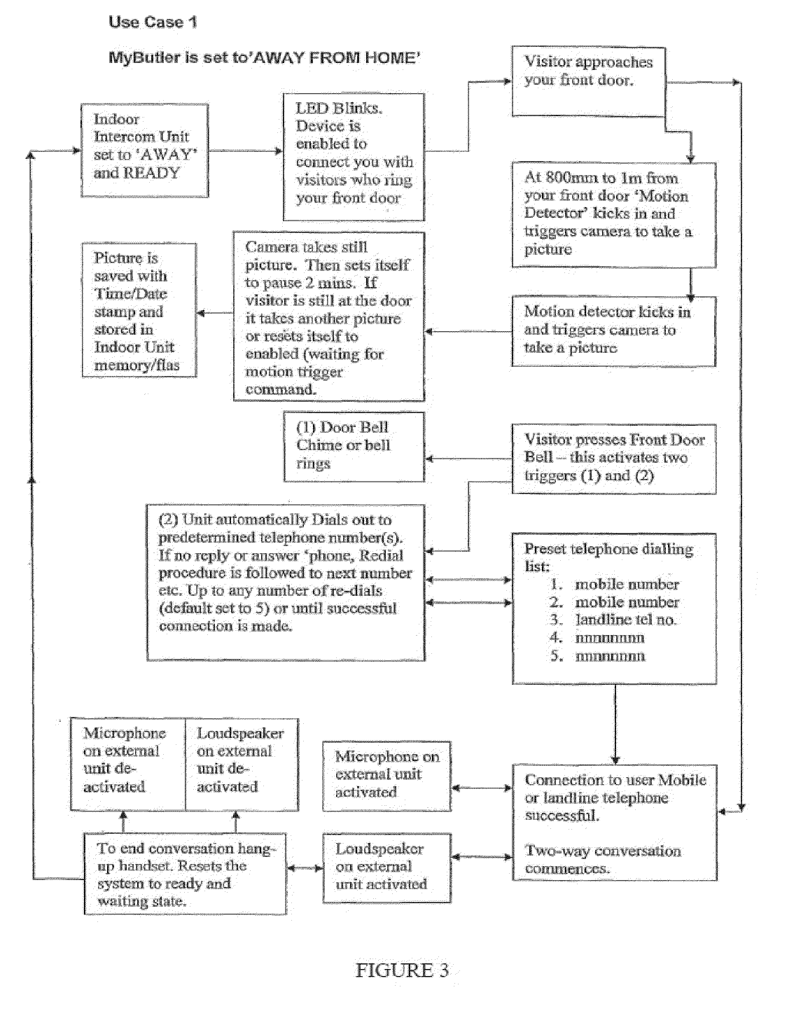

FIG. 4 depicts an example of a flowchart of a method indicating potential modes of operation of the security device, with the device set to “AT HOME.”

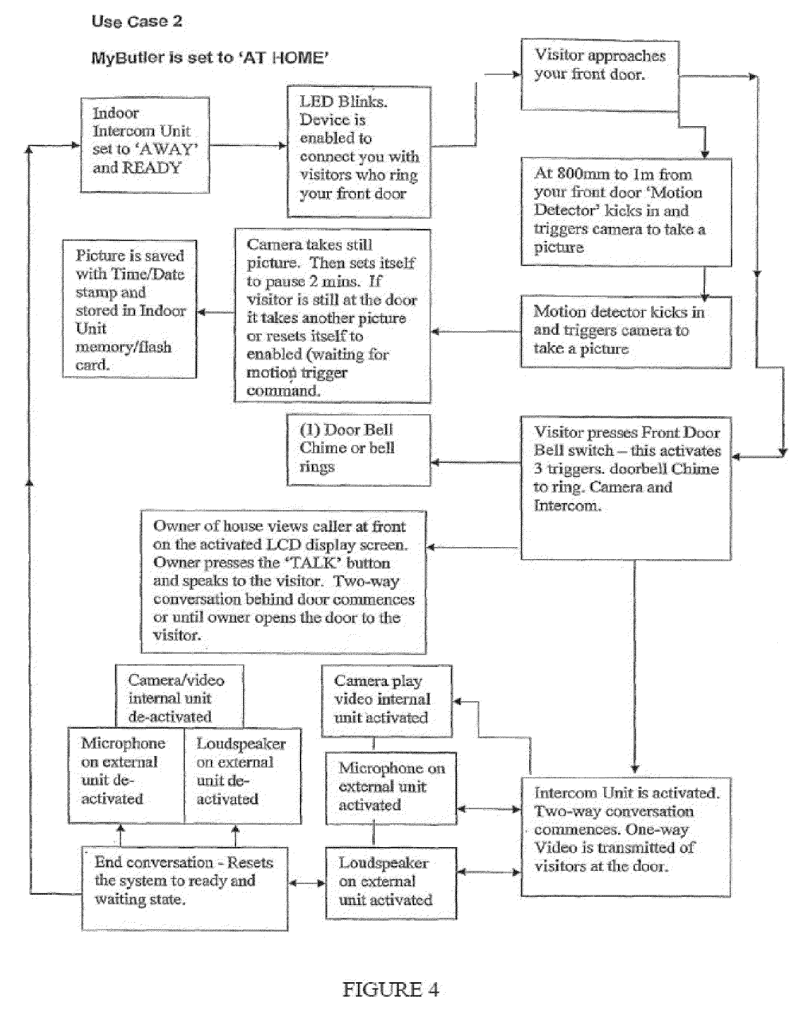

FIG. 5 depicts an example of a premise security management environment.

FIG. 6 depicts an example of a premise security web portal system.

FIG. 7 depicts an example of a flowchart of a method for controlling premise security with a premise security web portal system.

FIG. 8 depicts an example of an external device management engine.

FIG. 9 depicts an example of an event information gathering engine.

FIG. 10 depicts an example of a flowchart of a method for providing event information from an event information gathering engine.

FIG. 11 depicts an example of a live view information gathering engine.

FIG. 12 depicts an example of a flowchart of a method for providing live view information related to a premise security management web portal system.

FIG. 13 depicts an example of a system information gathering engine.

FIG. 14 depicts an example of a flowchart of a method for providing system information related to a premise security management web portal system.

FIG. 15 depicts an example of a premise appliance management engine.

FIG. 16 depicts an example of a flowchart of a method for managing one or more premise appliances.

FIG. 17 depicts an example of a premise security management environment.

FIG. 18A depicts an example of a premise security management environment.

FIG. 18B depicts an example of an architecture used to implement a premise security web portal system.

FIG. 19 depicts an example of a screen of a premise security web portal system.

FIG. 20 depicts an example of a computer system.

### DETAILED DESCRIPTION OF THE DRAWINGS

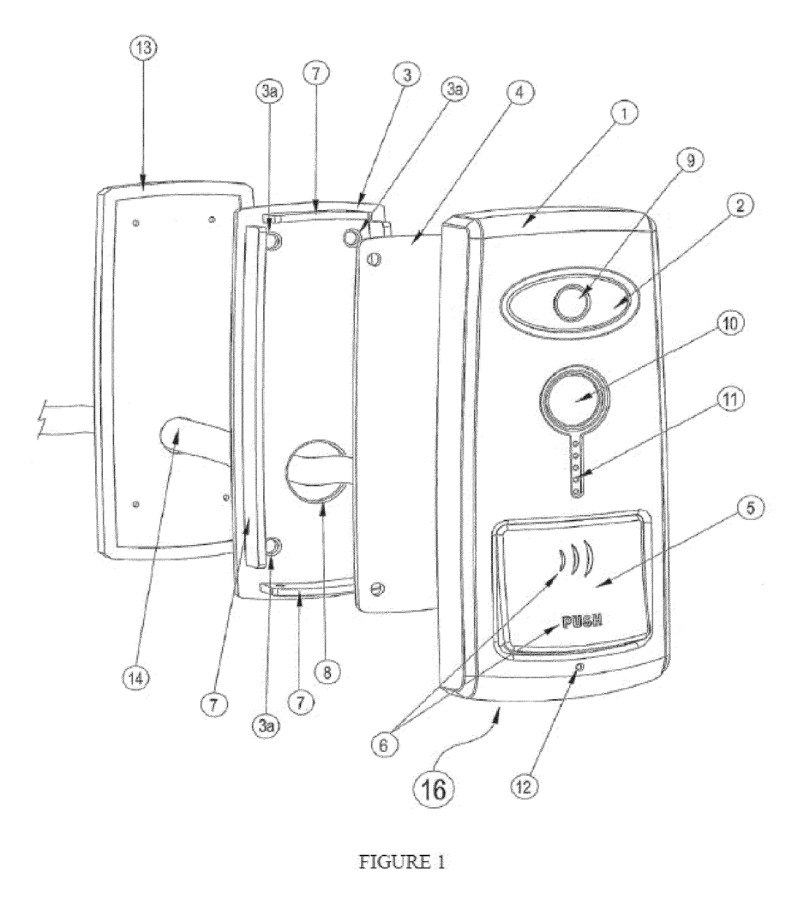

FIG. 1 depicts an example of a partially exploded perspective view 16 of a remote unit. In the example of FIG. 1, the remote unit comprises four separate basic components, a steel chassis (3), a circuit board (4) (which also functions as a sub-frame), a plastic molding (1) and a seal (13).

Appropriate holes (3a) are provided in the steel chassis (3), to enable the steel chassis (3) to be mounted to a door frame or a suitable surface (such that the device may be used as an entrance monitoring device) by the use of screws (not shown), three of the four holes (3a) provided are shown on FIG. 1.

An orifice (8) is also provided in the steel chassis (3) to allow the passage of cables (14) through the chassis (3). The cables may be used to connect the remote unit to the base unit and/or to supply power to the remote unit (16).

A series of protruding sections (7) are provided in the steel chassis, such protrusions may act as means to ensure that plastic molding and circuit board are correctly located relative to the steel chassis (3), when the separate components (1), (3) and (4) of the remote unit are assembled to form a single unit. Alternatively the protrusions may act to ensure that a rubber seal (not shown), used to weather-proof the assembled unit (16), is maintained in an appropriate orientation with respect to the plastic molding (1) and the steel chassis (3) during assembly of the remote unit (16). When the protruding sections (7) form a guide for such a seal (not shown), the seal is initially positioned around the raised protrusions (7) prior to the circuit board (4) and plastic molding being positioned in the appropriate location relative to the steel chassis (3).

The circuit board (4) serves as a sub-frame onto which all of the electronic components such as the camera, speaker, microphone, etc. may be mounted, the circuit board (4) itself being mounted in the plastic molding (1).

A number of components are incorporated into the front face of the plastic molding (1) these comprise a plastic lens cover (2), a camera lens (9), a detector (10) which may be an ultrasonic detector, a passive infrared detector, or other such suitable detector of a type that would be known to the skilled addressee, a speaker (11), a manually activated switch (5) and a microphone (12).

The manually activated switch (5) is mounted into the plastic molding in such a way that it operates as a rocker switch. A light emitting diode (LED) (not shown) is mounted within the switch (5) in order to illuminate the switch from within, the LED being connected to the circuit board (4). The switch (5) furthermore incorporates portions, which are manufactured from clear plastic as indicated by (6).

The remote unit (16) may also be weather proofed (i.e. protected from water damage) by coating the internal computer or the unit as a whole with suitable waterproofing materials in the form of sprays or dips. Any clearance space between the switch and the plastic molding (1) may also be weather proofed by means of a second seal (not shown).

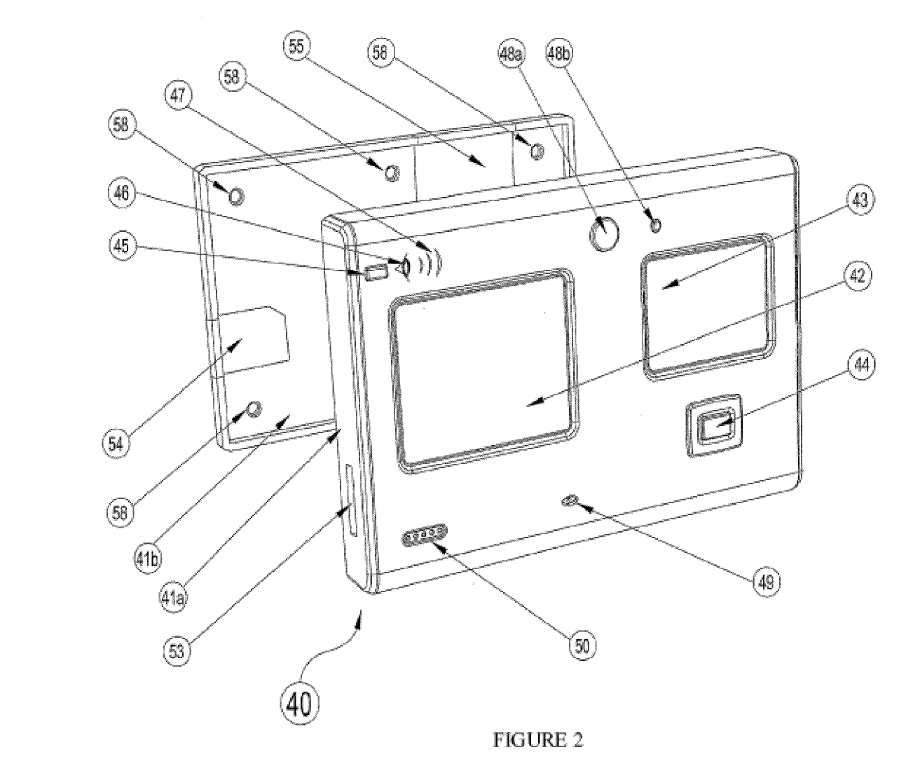

Reference will now be made to FIG. 2 of the drawings, wherein a partially exploded perspective view of the base unit as generally indicated by (40) is shown.

The base unit (40) includes a housing formed in two parts (41a and 41b); the two parts can be manufactured from plastics material or the like.

The rear part (41b) of the housing includes two keyhole shaped slots (not shown) to allow the unit to be mounted on a wall, or other suitable surface, by the use of screws-other suitable fixing means may also be used.

The rear part of the housing (41b) is secured to the front of the molding (41a) by the use of six screws which insert into openings (58) in the rear housing (41b), only four of the six openings are shown, and insert into corresponding portions in the front housing (41a).

Alternative means such as push dip mechanisms, or similar fixing means-as would be known to the skilled addressee-may be used to connect the front housing (41a) to the rear housing (41b).

The rear part of the housing (41b) further incorporates a removable door (54) to allow the insertion of a SIM card into the device (if appropriate) and a second removable door (55) is provided to allow the insertion and replacement of batteries. Further doors (not shown) may be provided in the rear part of the housing to allow the insertion of a plug socket for mains power supply, and/or a plug socket to connect the device to a remote monitor and/or a plug socket to connect the device to a fixed telephone line.

The front part of the housing (41a) provides a slot 53 for the insertion of a smart card and also incorporates a screen (LCD or the like) to display images collected by the camera of the remote unit. Also provided are a keyboard (43) and joystick (44) to allow a user to access menus to control the set-up of the device and to allow the entry of relevant data such as telephone numbers.

A power switch (45) is provided together with a power indicator light (46). A low battery/alarm function (47) provides a warning to user of the device when the batteries need replacing.

A switch in the form of a button (48a) is provided to allow the base unit to be used as a standard intercom and an indicator (48b) in the form of an LED is provided to indicate that the button has been pressed sufficiently hard to activate the intercom.

A microphone (49) and speaker (50) are also incorporated into the front part of the housing (41a) to allow communication between the base unit (30) and the remote unit (16).

All necessary electronic components including circuit boards and aerials are incorporated into the front part of the housing (41a).

In use a person approaching the remote unit (16) is detected by the detector (10) which activates the camera such that one or more photographs are taken and/or alternatively the approach of the person is recorded as a video image. The picture(s)/video images being saved remotely from the remote unit, either by suitable means provided in the base unit or by alternative suitable data storage means, such that if the remote unit is vandalized or stolen the images are retained. The number of photographs to be taken and/or length of time for which video images are to be recorded may be preset by a user via the base unit. The photographs or video images may be subsequently viewed using the screen (42).

The detection of a person by the detector (10) also activates the LED which illuminates the switch (5) such that the approaching person's attention is automatically drawn to the switch (5) to encourage use of the switch (5). The LED is set to automatically switch off after a pre-set interval of time which may range from a few seconds to several minutes.

If the person presses the switch (5) then the base unit may activate the production of an audible alarm signal by the remote unit. Such that the person pressing the switch (5) is led to believe that the switch activates a standard doorbell type mechanism. A second person, within the premises, hearing the audible alarm signal may then use the base unit (40) as a standard intercom by pressing the button (48a) to establish audio communication between the remote unit (16) and the base unit (40). The screen (42) may be used to display images from the camera of the remote unit (16) during such communication.

When a second person is not available within the premises to use the base unit (40) as a standard intercom the base unit (40) may be manually set to dial a series of preprogrammed telephone numbers in a pre-determined order. In this way a second person answering a dialed telephone may communicate with the first person via the base unit (40) and remote unit (16). Alternatively the base unit (40) may automatically start the dialing of the relevant telephone number if the button (48a) is not pressed within a predetermined time interval from the activation of the switch (5).

Once the second person, answering a dialed telephone hangs up the telephone connection established by the base unit is automatically disconnected.

In this way a first person activating the switch is not able to determine whether the second person with whom they communicate is within premises entered by an entryway adjacent the remote unit or is at a remote location. Thus the base unit (40) and remote unit (16) act as a security device dissuading a first person from illegally entering the premises concerned.

The base unit may utilize a standard land line or may use a mobile telephone connection to dial the relevant telephone numbers.

Smart cards used with the base unit may provide a medium for the storage of images; such images may also be stored on storage devices provided separately from the base unit (40) and remote unit (16).

Alternatively the smart card may be a pre-payment card of the type used with ‘Pay as You Go’ type mobile phones if the base unit utilizes a mobile phone as the primary means for dialing other telephones, or as backup in the event that the land line used as a primary telephone connection fails to function properly.

In the particular embodiment described above the communication between the first person via the remote unit and a second person called on a telephone would normally be voice to voice, although alternative means could be utilized such as 3G technology to enable the second person called on a telephone to view images collected by the camera. Alternatively a screen may be incorporated into the remote unit to allow video to video communication between the remote unit and the base unit, or between the remote unit and a second person called on a telephone.

Means may be provided to provide automatic transmission of photographs or video images taken by the camera to a dialed telephone even if the switch (5) is not activated.

Communication between the base unit (40) and the remote unit (16) may be via cable, Bluetooth connection, or any other form of suitable communication means as would be known to the skilled addressee.

The activation of the security device disclosed herein may be prevented without the insertion of an appropriately coded SIM card, even if the device is utilizing a landline rather than a mobile connection. The SIM card may also allow the activation of the device to be remotely controlled by the supplier of the SIM or by the supplier of the telephone connection or by the original equipment manufacturer (OEM).

In summary special advantages provided include:

A security device for monitoring an entrance door to any building, for example home, office, garage etc.

A security monitoring device for monitoring cars or any other valuable items.

A security monitoring device with real time interaction, allowing two-way conversation.

A security monitoring device that is activated by the approach and/or operation of a ‘doorbell’ type switch.

A security monitoring device that connects its owner to a visitor anywhere in the world via telephonic communication.

A security monitoring device that photographs potential visitors on approach.

A security monitoring device that utilizes second (2G), third (3G), fourth (4G) and/or future generations of mobile technology platforms.

A security monitoring device that is able to connect directly to second (2G), third (3G), fourth (4G) and/or future generations of mobile technology platforms.

A security monitoring device that is able to connect directly to land lines.

A security monitoring device wherein a remote ‘bell push’ activates a telephone dial-out mechanism.

A security monitoring device wherein further triggers can be remotely placed for example at an entrance gate for activating photographic or video recording means.

Enabled herein are homeowners and the like, who are away from their premises to interact with visitors calling at their premises. Known surveillance and home security systems monitor intrusive activity to the home or office, but do not include instant two-way interaction with the owner of the premises.

The real time interaction between the visitor and the owner of the property are ensured at all times, whether the owner is indoors or away from their property. The mobile network allows communications connection on a global platform. This means that the owner can be abroad and still be connected by voice or video to callers/visitors to their property. Preferably, the unit will be small enough to house all the electronic components and will fit all standard external doorframe widths.

Various embodiments may control access through gates to enclosed areas. Additionally known means may be provided to allow the device to be accessed remotely to; re-order the sequence in which the telephone numbers are dialed, to access images stored by the system, or to re-set the system if required.

When a dialed telephone is answered the use of a code entry may also be required to ensure that communication between the remote unit and the second person on the dialed telephone is not established before the second person is ready to communicate with the first person.

In a further embodiment of the security device, the remote unit and/or base unit incorporates a power supply unit, which does not incorporate any external wires, connectors or contacts. This may be in a typical form, such as an inductive coupling, which induces power into an inductive receiver, within the remote unit and/or base unit. The induced power is a magnetic field, transmitted from a typical charging pad. The charging pad may be located on or in the immediate vicinity of the remote unit and/or base unit.

In a further embodiment of the security device, the remote unit and/or base unit incorporates an additional key pad, display screen and speech recognition circuitry. These components are required for establishing two way communications with a person who is deaf. The visitor will activate the remote unit by pressing a switch and speaking into the remote unit's microphone. The visitor's speech is then converted into a textual representation, by the speech recognition circuitry, which is then communicated onto a display screen that is mounted internally in the house and/or transmitted to a mobile phone, which can be read by a person who is deaf. The deaf person will respond to the visitor's communication by entering textual response from either a keypad located internally within the house, or from a mobile phone. The textual response entered will then be converted into speech, by the speech recognition circuitry, which is then transmitted to the visitor.

This embodiment may be further enhanced by incorporating a touch screen display within the remote unit and/or base unit. A keypad may be incorporated within the touch screen. The touch screen will display a menu to the visitor, which offers “one touch” selection and communication means to visited person.

In a further embodiment of the security device, unique access codes are stored within the remote unit and/or base unit. The access codes are assigned to authorized person(s), to give them immediate access to the property. On entering the code the person is identified, the security device's camera will capture an image of the visitor, along with the time of the visit. A text message is then sent to the property owner's mobile phone, informing them of the identity of the visitor and at what time they gained access to the property.

In a further embodiment of the security device, the visitor may speak into remote unit's microphone to leave a message, which will be stored in the security device's remote unit and/or base unit. The security device will capture an image of the visitor, as well as the audio message, when the visitor activates an intercom/doorbell switch and/or movement sensor(s).

This embodiment may be further enhanced by incorporating biometric scanning devices to the remote unit and/or base unit. The biometric scans of authorized person(s) are stored within the remote unit and/or base unit, to give them immediate access to the property. On entering the biometric scan, typically a fingerprint, handprint or retina scan, the person is identified. The security device's camera will capture an image of the visitor, along with the time of the visit. A text message is then sent to the property owner's mobile phone, informing them of the identity of the visitor and at what time they gained access to the property.

In a further embodiment of the security device, the remote unit and/or base unit incorporates an additional brail keypad, brail intercom/doorbell switch and a sounding device. These components are required for establishing two way communications with a person who is blind. A blind visitor will be guided to the remote unit, by a sounding device located in close proximity to the remote unit. The sounding device will be activated by the activation of a movement detector located in close proximity to the remote unit. Once the blind visitor has located the remote unit, they can determine the functionality of the keys on the keypad and/or intercom/doorbell switch, by feeling the brail text located upon the components. Therefore, audio, visual and/or textual communication is established to the inside of the house and/or transmitted to a mobile phone.

In a further embodiment of the security device, predetermined text messages are stored within the remote unit and/or base unit. These text messages are assigned to activations of the security device, which are dependent upon an array of discrete sensors. Each discrete sensor is mapped to an individual function, for example, a sensor monitoring a zone within the garden, a sensor monitoring a zone within the garage and/or a sensor monitoring a particular door or window. Therefore, when a sensor is activated, i.e. a sensor located within a garage, the security device will transmit a text message across the mobile network and/or internet, to the house owner's mobile phone, informing them of a potential security threat to their garage.

This embodiment may be further enhanced by incorporating a means for remotely operating an illumination device(s), audible device(s), slave camera(s) and/or any other remote devices, by entering predetermined codes from the house owner's mobile phone, which are then transmitted across the mobile network and/or internet to the security device.

This embodiment may be further enhanced by incorporating one or more docking ports for the insertion of a removable wireless network transceiver module, typically a Universal Serial Bus (USB) “Bluetooth” ® or “IEEE 802.11” wireless network modules. Therefore, all remote sensors, remote cameras and/or remote units are wirelessly networked to the security device.

In a further embodiment of the security device, all activations are time stamped and logged within the remote unit and/or base unit, for inspection and retrieval at a later time.

This embodiment may be further enhanced by incorporating one or more docking port for the insertion of a removable memory module, typically a Universal Serial Bus (USB) memory device. This device may be used for dumping and backing up the security device's activation data log and/or stored security data.

In a further embodiment of the security device, the data obtained is transmitted across a mobile network and/or the internet to a dedicated gallery domain, which resides on the World Wide Web. This gallery provides an access means to the security data stored for a particular security device. The gallery will manage the retrieval and use of the data. Typically the gallery provides a means for remotely accessing and responding to the stored data from places abroad.

In a further embodiment of the security device, the remote unit and/or base unit incorporates an additional alarm device. This may typically be an audio and/or visual alarm device. The property owner may activate the alarm by pressing a predetermined button or switch on the base unit or by transmitting a code, entered from their mobile phone, across a mobile network and/or internet to activate the alarm remotely.

This embodiment may be further enhanced by incorporating an interface means which connects the security device to an existing alarm system within the property. The property owner may activate the alarm by pressing a predetermined button or switch on the base unit or by transmitting a code, entered from their mobile phone, across a mobile network and/or internet to activate the alarm remotely.

In a further embodiment of the security device, the remote unit and/or base unit incorporates a Subscriber Identity Module (SIM), for authentication of mobile network connection. The owner of the security device may enter into a service contract with a mobile network provider. The network provider will issue a dedicated SIM for the security device, enabling it to connect to the mobile network. The security device owner may after the contract term has expired, renegotiate a service with another mobile network provider, who will then issue their own dedicated SIM, which supersedes any existing SIM within the security device. The SIM is intended to be a static device, and not a roaming device, like a conventional SIM for a mobile phone. Therefore, a fixed address is established for billing. The dedicated SIM for the security device will generate additional revenue streams for the mobile network companies. The revenue streams comprise offering new fixed term contracts between customers and network providers for security services. The new fixed term contracts will typically provide, for each customer account, a SIM, a new dedicated number for the security device and a range of air time tariffs for the security device.

The security device in combination with its dedicated SIM will maintain the integrity of the mobile network connection, data verification checks and enable the authorization of the security device to connect with the mobile network in response to any network challenges to the SIM's authenticity.

The mobile network provider may monitor the actual location of the SIM by establishing its position via the cells within the mobile network. If the SIM is shown to be roaming, then the mobile network provider has the option of disabling the SIM and informing the security device owner of the potential security risk.

In a further embodiment of the security device, the remote unit and/or base unit may be incorporated as static devices, within a non-static platform. These platforms are typically land vehicles, floating vehicles and/or airborne vehicles. The remote unit and/or base unit incorporate additional Global Positioning System (GPS) circuitry. These components are required for transmitting GPS coordinates across the mobile network and/or internet via a wireless internet connection, to update the present location of the platform. This embodiment will enable successful tracking of the platform, in the event of it being stolen or misused.

The remote unit and/or base unit incorporated within the platform will record any instances which trigger any activation from sensors within the platform and/or any remote activation from platform owner, police enforcement departments or contracted security companies. The security data obtained may be used as potential evidence, later at any subsequent legal proceedings. The remote unit and/or base unit incorporated within the platform will enable two-way communication between the platform owner and the people being monitored within the platform.

This embodiment may be further enhanced by connecting the security device to the control and/or management systems of the platform. Therefore enabling the platform owner, police enforcement departments or contracted security companies to remotely shutdown and immobilize the platform. The platform may engage locks, which have been activated remotely to contain the people being monitored within the platform.

In a further embodiment of the security device, the remote unit and/or base unit may be used to monitor a specific area. The security device transmits over a mobile network and/or the internet, audio and visual data, which establishes communication between a property owner, law enforce department or private security company and any person(s) monitored within the area. Once communication has been established, the persons(s) monitored by the security device are informed, typically by a loudspeaker, that they are being monitored. The security data obtained may be used as potential evidence, later at any subsequent legal proceedings.

In a further embodiment of the security device, the security device functionality maybe incorporated into an integrated single unit to reduce the security devices physical size, i.e. for miniaturization of the security device for new applications.

This embodiment may be further enhanced by incorporating the security device into a portable computer, typically a laptop, notebook or Personal Digital Assistant (PDA). Therefore, if a portable computer or PDA is stolen, and the thief attempts to use it without deactivating the security device first. The computer or PDA will capture an image of the thief and transmit it across a mobile network and/or the internet to the owner's mobile phone and/or predetermined web domain. The laptop or PDA will then deactivate itself, typically going into a sleep state and disenable any user interface. The laptop or PDA will then permanently display a message onto the screen, i.e. “THIS DEVICE HAS BEEN STOLEN AND IS CURRENTLY TRANSMITTING A TRACKING SIGNAL”, and/or activate a loud audible alarm.

This embodiment may be further enhanced by incorporating the security device into children's jewelry, typically bangles and/or necklaces, which can capture images of who they are with and with whom they have been. This embodiment may be used to provide security for a child.

This embodiment maybe further enhanced by utilizing the security device as a data logging device, which depicts the child's life from when they were a young child to adulthood, as a historic gallery of images.

This embodiment maybe further enhanced by incorporating the security device into clothing. Therefore, when going on holidays it captures images on a regular basis of what you did, where you were and what you were doing. This embodiment embeds all the required functionality, to capture the images, within the clothing. This embodiment eliminates the need to operate a camcorder or camera. Therefore, this embodiment may be advantageous for work practices, when the wearer's clothing captures images of the processes performed by the wearer.

In a further embodiment of the security device, the security device's activation will be triggered by a sharp, snatched movement. Therefore, once the security device is activated an alarm will be generated; this may be typically in the form of an ear piercing alarm, or an audible circuitry playing in a set loop sounding i.e. “This is stolen property”. A Personal Identification Number (PIN) will be required to be entered, into the security device, to turn it off. This embodiment may be used to secure handbags, brief cases, portable computers or anything else which is portable or valuable.

Further potential embodiments of the security device are as follows:
Fashion, particularly accessories such as handbags and wallets;
Back of jackets (in the neck or collar);
Back of a safe, which monitors those who are using it;
A computer screen, which monitors those who are using it and/or activating it by keystroke;
Doors and/or windows, which monitors those who are opening them;
Mobile phones, which monitors those who are using them;
Passports and ID documents;
Legal document folders;
Covert aircraft surveillance, where hatches that have been opened by ground staff are monitored, to capture who opened the hatch, who or what embarked or disembarked the aircraft via the hatch and what they were doing;
Passport control and/or immigration;
Road signs, which monitor traffic conditions;
Evolution of a process over a long period where you don't want continuous monitoring but want detailed data i.e. like a car journey;
Any weapons, munitions or storage devices, which capture the images of people who open them.

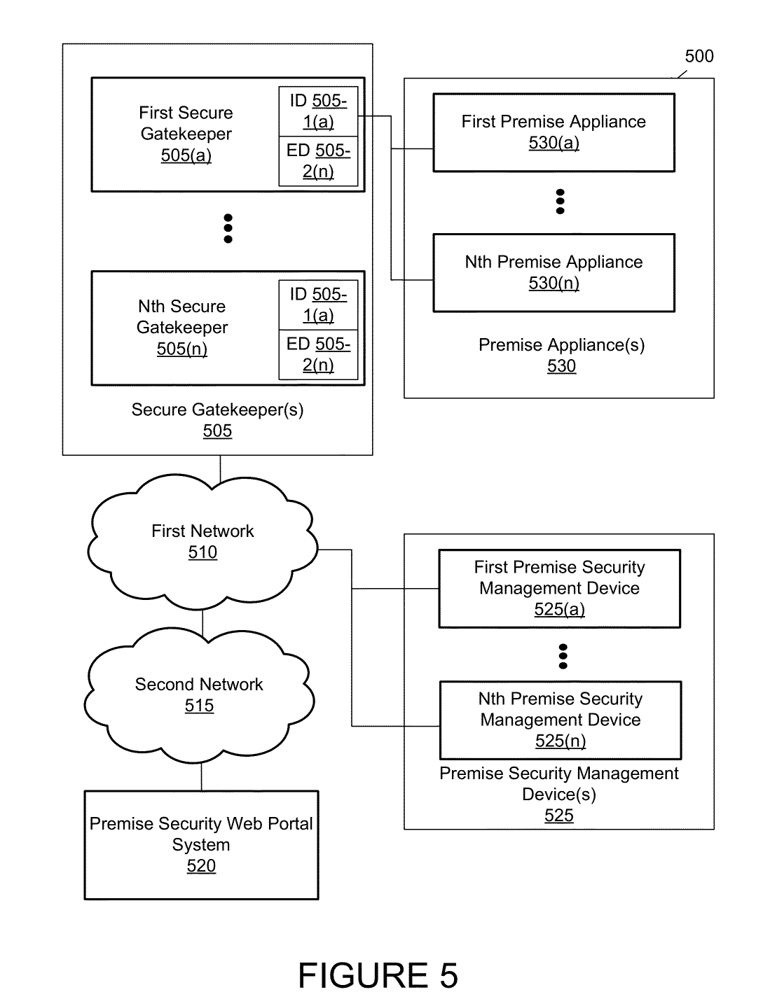

FIG. 5 depicts an example of a premise security management environment 500. In various implementations, provided in the premise security management environment 500 provides security for premises using secure gatekeepers (e.g., the secure gatekeeper(s) 505 discussed further herein) connected to cellular networks and manageable from any device having a network connection.

In some implementations, the premise security management environment 500 allows remote management of access to premises. As one example, a person may have an elderly parent who lives alone. The premise security management environment 500 may allow the person to remotely monitor callers at the mother's house and to remotely intervene when visitors show up at the front door of the mother's house. As another example, another person to remotely monitor when his or her children are at home, and remotely control appliances (e.g., the premise appliance(s) 530) for the person's children. As yet another example, yet another person employing a babysitter may be able to remotely intervene when strangers ring the doorbell to the premises; the person may further be able to remotely keep in direct contact with anyone at the front door of the premises and may be able to remotely receive pictures, video, and other information of the people at the front door of the premises.

In various implementations, the premise security management environment 500 can allow for assisted living for elderly people. For instance, in some implementations, the premise security management environment 500 can allow for controlled access and automatic time and date logs of entries and exits of caretakers. In some implementations, the premise security management environment 500 can allow for the provision of telecare services. More specifically, panic signals and/or fall callout signals can be registered at a control center. Call alerts for emergencies can be sent to immediate family or to a registered call center. Alerts for floods, power cuts, smoke and fire, gas leaks, carbon monoxide leaks, etc. can be set up. In various implementations, the premise security management environment 500 can allow for home monitoring and automation. That is, the premise security management environment 500 can allow for remote control of energy consumption, turning on/off of lights and/or domestic appliances, automation of locking and/or unlocking doors, turning cooling and/or heating systems on or off, setting and/or resetting house profiles remotely, etc.

In the example of FIG. 5, the premise security management environment 500 includes secure gatekeeper(s) 505, a first network 510, a second network 515, a premise security web portal system 520, premise security management device(s) 525, and premise appliance(s) 530. In various implementations, one or more of the premise security management device(s) 525, the first network 510, the second network 515, the premise security web portal system 520, the secure gatekeeper(s) 505, and the premise appliance(s) 530 contain “engines,” and/or “datastores,” as described herein. An “engine,” as used in this paper, includes a dedicated or shared processor and, typically, firmware or software modules executed by the processor. Depending upon implementation-specific or other considerations, an engine can be centralized or its functionality distributed. An engine can include special purpose hardware, firmware, or software embodied in a computer-readable medium for execution by the processor.

A “datastore,” as used in this paper, can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper. Datastores can include data structures. As used in this paper, a data structure is associated with a particular way of storing and organizing data in a computer so it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself Many data structures use both principles, sometimes combined in non-trivial ways. The implementation of a data structure usually entails writing a set of procedures for creating and manipulating instances of that structure.

In the example of FIG. 5, the secure gatekeeper(s) 505 are coupled to the first network 510. In a specific implementation, the secure gatekeeper(s) 505 include a first secure gatekeeper 505(a) through an nth secure gatekeeper 505(n). It is noted the letter “n” designates an arbitrary number, and the secure gatekeeper(s) 505 may include more or less than the devices depicted in FIG. 5, in various implementations. In a particular implementation, each of the secure gatekeeper(s) 505 monitors a portion of premises. Monitoring may include capturing images, video, and sound of the portion of the premises. Monitoring may also include detecting motion near the portion of the premises. In an implementation, each of the secure gatekeeper(s) 505 provides, over the first network 510, information about the portion of the premises being monitored. In various implementations, each of the secure gatekeeper(s) 505 contains a display that shows a person associated with the premises. In some implementations, the display may provide information captured remotely, such as images, video, or sound from the premise security management device(s) 525, as discussed herein. In some implementations, each of the secure gatekeeper(s) 505 is controlled by the premise security web portal system 520, as discussed herein. In various implementations, the secure gatekeepers may correspond to a security unit, comprising the base unit (40) and the remote unit (16), described herein.

In the example of FIG. 5, each of the secure gatekeeper(s) 505 includes an internal device 505-1 and an external device 505-2. The internal device 505-1 may be coupled to the premise appliance(s) 530. In an implementation, the internal device 505-1 resides in a secure portion area of the premises. For instance, the internal device 505-1 may reside inside a house that is secured by the secure gatekeeper(s) 505 or may reside within a safe area of the secure gatekeeper(s) 505. The internal device 505-1 may internally include a connection to the first network 510. In various implementations, the internal device 505-1 corresponds to the base unit (40) shown and illustrated herein. In various implementations, the connection to the first network 510 may include a remote power source and a cellular connection, neither of which are dependent on power lines, wired network connections, routers, etc. As a result, in various implementations, even if a power line, a wired network connection, a router, etc. is cut or otherwise disabled by an intruder, the internal device 505-1 may continue to function and may provide a premise occupant with connectivity to the first network 510. In some implementations, the internal device 505-1 may include a battery backup module that lasts for an extended period (e.g., several days). The battery backup module may be refreshed by hard-wired power connection. In various implementations, the internal device 505-1 further connects to the premise appliance(s), and includes encryption techniques to ensure data is securely provided the first network 510.

In a specific implementation, the external device 505-2 resides in an unsecure portion of the premises and is operatively coupled to the internal device 505-1 either directly (as shown in FIG. 5) or through the first network 510. For instance, the external device 505-2 may reside outside a house secured by the secure gatekeeper(s) 505 or may reside outside a safe area of the secure gatekeeper(s) 505. In an implementation, the external device 505-2 includes an indicator such as a bell (or other indicator) for a visitor to ring. In various implementations, the external device 505-2 corresponds to the remote unit (16) shown and illustrated herein. The indicator may show, on a display of the external device 505-2, images and/or video of an occupant of the premises and/or one or more users of the premise security management device(s) 525. The occupant of the premises may be provided through the camera on the internal device 505-1 as discussed herein.

In some implementations, the external device 505-2 may include a remote power source and a cellular connection, neither of which are dependent on power lines, wired network connections, routers, etc. As a result, in various implementations, even if a power line, a wired network connection, a router, etc. is cut or otherwise disabled by an intruder, the external device 505-2 may continue to function and may provide a premise occupant with connectivity to the first network 510. The external device 505-2 may also include a battery backup module that lasts for an extended period and that may be refreshed by a hard-wired power connection.

In some implementations, the external device 505-2 can provide two-way voice and/or cellular data over the first network 510. The external device 505-2 may further take pictures and/or videos, and may log the time(s)/date(s) and other information of the pictures and/or videos. In an implementation, the external device 505-2 can include a motion sensor, such as an infrared sensor. In these implementations, cameras and other portions of the external device 505-2 need not record until the motion sensor indicates the presence of something, e.g., a visitor, nearby. The external device 505-2 may further log entry and/or exit times of visitors, and provide a display that shows images and/or video of premise occupants and/or users of the premise security management device(s) 525, as discussed herein. The external device 505-2 may further allow occupants and/or users of the premise security management device(s) 525 to manually take pictures of visitors, and may include anti-tamper and/or early warning alert systems to prevent security attacks on the secure gatekeeper(s) 505.

In the example of FIG. 5, the first network 510 is coupled to the secure gatekeeper(s) 505, the second network 515, and the premise security management device(s) 525. In a specific implementation, the first network 510 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the first network 510 broadly includes, as understood from relevant context, anything from a minimalist coupling of the components illustrated in the example of FIG. 1, to every component of the Internet and networks coupled to the Internet. In some implementations, the first network 510 is administered by a service provider, such as an Internet Service Provider (ISP).

In various implementations, the first network 510 may include technologies such as Ethernet, 802.11, worldwide interoperability for microwave access (WiMAX), 3G, 4G, CDMA, GSM, LTE, digital subscriber line (DSL), etc. The first network 510 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over first network 510 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the first network 510 includes a wired network using wires for at least some communications. In some implementations, the first network 510 comprises a wireless network. A “wireless network,” as used in this paper may include any computer network communicating at least in part without the use of electrical wires. In various implementations, the first network 510 includes technologies such as Ethernet, 802.11, worldwide interoperability for microwave access (WiMAX), 3G, 4G, CDMA, GSM, LTE, digital subscriber line (DSL), etc. The first network 510 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the first network 510 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the first network 510 is compatible with the 802.11 protocols specified by the Institute of Electrical and Electronics Engineers (IEEE). In a specific implementation, the wireless network of the first network 510 is compatible with the 802.3 protocols specified by the IEEE. In some implementations, IEEE 802.3 compatible protocols of the first network 510 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the first network 510. In some implementations, the first network 510 includes a cellular network. More specifically, in some implementations, the first network 510 allows the devices connected thereto to access cellular voice, cellular data, and/or other network services through cellular towers. The cellular towers used to support the first network 510 may be administered by cellular phone and/or cellular data service providers.

In the example of FIG. 5, the second network 515 may be coupled to the first network 510 and the premise security web portal system 520. In a specific implementation, the second network 515 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the second network 515 broadly includes, as understood from relevant context, anything from a minimalist coupling of the components illustrated in the example of FIG. 1, to every component of the Internet and networks coupled to the Internet. In some implementations, the second network 515 is administered by a service provider, such as an Internet Service Provider (ISP).

In various implementations, the second network 515 may include technologies such as Ethernet, 802.11, worldwide interoperability for microwave access (WiMAX), 3G, 4G, CDMA, GSM, LTE, digital subscriber line (DSL), etc. The second network 515 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over second network 515 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the second network 515 includes a wired network using wires for at least some communications. In some implementations, the second network 515 comprises a wireless network. A “wireless network,” as used in this paper may include any computer network communicating at least in part without the use of electrical wires. In various implementations, the second network 515 includes technologies such as Ethernet, 802.11, worldwide interoperability for microwave access (WiMAX), 3G, 4G, CDMA, GSM, LTE, digital subscriber line (DSL), etc. The second network 515 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the second network 515 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the second network 515 is compatible with the 802.11 protocols specified by the Institute of Electrical and Electronics Engineers (IEEE). In a specific implementation, the wireless network of the second network 515 is compatible with the 802.3 protocols specified by the IEEE. In some implementations, IEEE 802.3 compatible protocols of the second network 515 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the second network 515. In some implementations, the second network 515 includes a cellular network. More specifically, in some implementations, the second network 515 allows the devices connected thereto to access cellular voice, cellular data, and/or other network services through cellular towers. The cellular towers used to support the second network 515 may be administered by cellular phone and/or cellular data service providers. In some implementations, the second network 515 need not comprise a cellular network. That is, in some implementations, the second network 515 may include portions of the Internet without the need for support from cellular towers.

In the example of FIG. 5, the premise security web portal system 520 is coupled to the second network 515. In an implementation, the premise security web portal system 520 provides a web portal for managing the secure gatekeeper(s) 505, managing the premise appliance(s) 530, managing related settings, and managing related user accounts. In various implementations, the premise security web portal system 520 controls, over the first network 510, the secure gatekeeper(s) 505 using instructions provided at least in part through the first network 510. In various implementations, the premise security web portal system 520 provides to the premise security management device(s) 525 images, sounds, and/or video with the external device 505-2 of the secure gatekeeper(s) 505. The premise security web portal system 520 can further provide to the premise security management device(s) 525 changes in state regarding motion sensors, infrared sensors, etc. on the external device 505-2. The premise security web portal system 520 can also provide to the premise security management device(s) 525 account settings and/or other information (e.g., to manage the premise appliance(s) 530) as discussed herein.

In the example of FIG. 5, the premise security management device(s) 525 are coupled to the first network 510. In a specific implementation, the premise security management device(s) 525 include a first premise security management device(s) 525(a) through an nth premise security management device(s) 525(n). It is noted again the letter “n” designates an arbitrary number, and that certain implementations of the premise security management device(s) 525 may include more or less than the devices depicted in FIG. 5. In a specific implementation, each of the premise security management device(s) 525 allows a user to manage the secure gatekeeper(s) 505, the premise security web portal system 520, and/or the premise appliance(s) 530. In some implementations, each of the premise security management device(s) 525 can include a camera and/or a microphone to allow users the ability to remotely interface with the secure gatekeeper(s) 505. More specifically, the premise security management device(s) 525 may allow people to exchange images, sounds, and/or video with the external device 505-2 of the secure gatekeeper(s) 505. The premise security management device(s) 525 may also be alerted to changes in state regarding motion sensors, infrared sensors, etc. on the external device 505-2. In various implementations, the premise security management device(s) 525 allow users to manage account settings related to the premise security web portal system 520, as discussed further herein.

In various implementations, the premise security management device(s) 525 can include a standalone application. An example of a standalone application can include a native mobile application executed on the premise security management device(s) 525. The standalone application can include some or of all of the engines used to manage the secure gatekeeper(s) 505, the premise security web portal system 520, and/or the premise appliance(s) 530. In some implementations, the premise security management device(s) 525 includes a container application, such as a web browser. The container application may include some or of all of the engines used to manage the secure gatekeeper(s) 505, the premise security web portal system 520, and/or the premise appliance(s) 530.

In the example of FIG. 5, the premise appliance(s) 530 are coupled to one or more of the internal device 505-1. In various implementations, the premise appliance(s) 530 include appliances that are controlled by the internal device 505-1. To this end, the premise appliance(s) 530 can be controlled directly by the internal device 505-1 or can be controlled through the premise security web portal system 520. In some implementations, the premise appliance(s) 530 can be controlled by the premise security management device(s) 525. In various implementations, the premise appliance(s) 530 can include one or more of: lamps, media centers, appliances or devices including computers, appliances or devices including near study areas, heating or cooling systems, and other appliances, devices, or apparatuses.

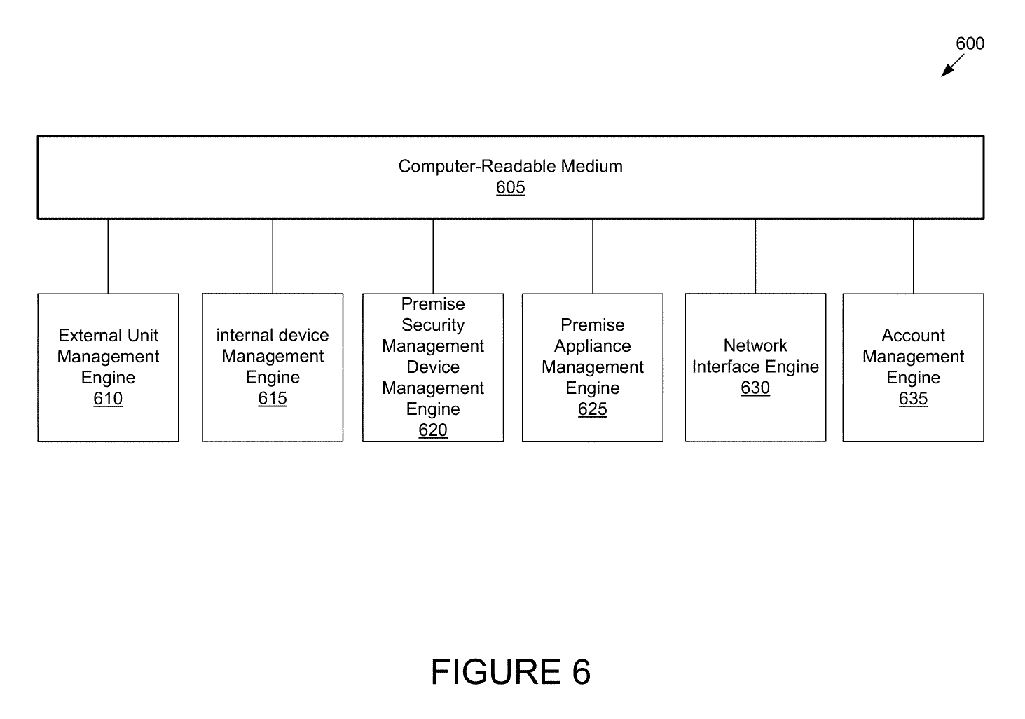

FIG. 6 depicts an example of a premise security web portal system 600. In the example of FIG. 6, the premise security web portal system 600 includes a computer-readable medium 605, an external device management engine 610, an internal device management engine 615, a premise security management device management engine 620, a premise appliance management engine 625, a network interface engine 630, and an account management engine 635. In an implementation, the computer-readable medium 605 includes a “computer-readable medium,” as discussed herein. In various implementations, one or more of the external device management engine 610, the internal device management engine 615, the premise security management device management engine 620, the premise appliance management engine 625, the network interface engine 630, and the account management engine 635 includes one or more “engines,” and/or “datastores,” as described herein.

In the example of FIG. 6, the computer-readable medium 605 is coupled to the external device management engine 610, the internal device management engine 615, the premise security management device management engine 620, the premise appliance management engine 625, the network interface engine 630, and the account management engine 635. In an implementation, the computer-readable medium 605 includes a “computer-readable medium,” as discussed herein.

In the example of FIG. 6, the external device management engine 610 is coupled to the computer-readable medium 605. In an implementation, the external device management engine 610 manages external device(s) (e.g., external device 505-2) of secure gatekeeper(s) (e.g., the secure gatekeeper(s) 505, shown in FIG. 5). In an implementation, the external device management engine 610 receives notifications of events occurring on external device(s), receives images, sound, and video from the external device(s), and provides images, sound, and video to the external device(s). In various implementations, the external device management engine 610 controls external device(s). For instance, the external device management engine 610 can change a perspective or alter a live view of external device(s) in various implementations.

In the example of FIG. 6, the internal device management engine 615 is coupled to the computer-readable medium 605. In an implementation, the internal device management engine 615 manages internal device(s) (e.g., internal device 505-1) of secure gatekeeper(s) (e.g., the secure gatekeeper(s) 505, shown in FIG. 5). In various implementations, the internal device management engine 615 provides notifications of events occurring on internal device(s), receives images, sound, and video from the internal device(s), and provides images, sound, and video to the internal device(s). The internal device management engine 615 can also provide interactive menu(s) on the internal device(s) for the occupant of premises to interact with. The interactive menu(s) may be used to control associated external device(s), premise appliance(s), and/or other devices.

In the example of FIG. 6, the premise security management device management engine 620 is coupled to the computer-readable medium 605. In an implementation, the premise security management device management engine 620 manages premise security management device(s) (e.g., premise security management device(s) 525 shown in FIG. 5). In various implementations, the premise security management device management engine 620 provides notifications of events occurring on premise security management device(s), receives images, sound, and video from the premise security management device (s), and provides images, sound, and video to the premise security management device (s). The premise security management device management engine 620 can also provide interactive menu(s) on premise security management device(s) for a person associated with premises to interact with. The interactive menu(s) may be used to control associated external device(s), premise appliance(s), and/or other devices.

In the example of FIG. 6, the premise appliance management engine 625 is coupled to the computer-readable medium 605. In an implementation, the premise appliance management engine 625 manages premise appliance(s) (e.g., premise appliance(s) 530 shown in FIG. 5). In some implementations, control is achieved through interfacing with drivers on the premise appliance(s) 530.

In the example of FIG. 6, the network interface engine 630 is coupled to the computer-readable medium 605. In an implementation, the network interface engine 630 is configured to send and receive data to and from a network (e.g., the second network 515 shown in FIG. 5). The network interface engine 630 may also be configured to send and receive data to and from the first network 510, shown in FIG. 5. In various embodiments, the network interface engine 630 encrypts all data for transmission to one or more of the secure gatekeeper(s) 505, the premise security management device(s) 525, and/or the premise appliance(s) 630.

In the example of FIG. 6, the account management engine 635 is coupled to the computer-readable medium 605. In various implementations, the account management engine 635 allows management of accounts associated with one or more of the secure gatekeeper(s) 505, the premise security management device(s) 525, and/or the premise appliance(s) 630.

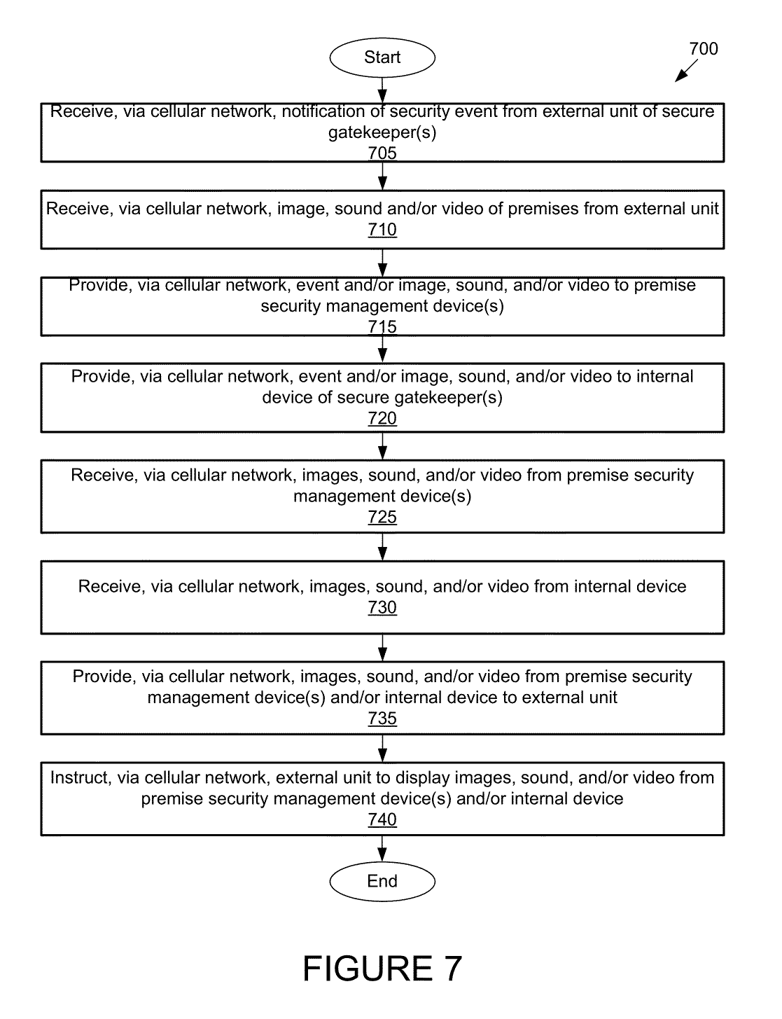

FIG. 7 depicts a flowchart 700 of an example of a method for controlling premise security with a premise security web portal system. In an implementation, the flowchart 700 is discussed in conjunction with the structures shown in FIG. 6. It is noted the flowchart 700 may have additional, fewer, or other modules than those depicted in FIG. 7.

At block 705, a notification of a security event is received via a cellular network from an external device of one or more secure gatekeeper(s). In various implementations, the external device management engine 610 receives a notification from an external device 505-2 of one or more of the secure gatekeeper(s) 505. In an implementation, the notification may include a presence indicator or other indicator that a visitor is near the external device 505-2. For instance, the notification may be based on the fact that a sensor (e.g., an infrared sensor) of the external device 505-2 was triggered. The notification may pass, at least in part, through the first network 510, which in this implementation may comprise a cellular network.

At block 710, an image, sound, and/or video of the premises is received in response to the notification and via the cellular network from the external device. In an implementation, the external device management engine 610 receives image, sound and/or video from the external device 505-2. In this implementation, the external device 505-2 may be configured to provide the image, sound, and/or video upon the notification. That is, the external device 505-2 may be configured to provide the image, sound, and/or video upon the fact that the sensor of the external device 505-2 was triggered. The image, sound, and/or video of the premises may be received, at least in part, through the first network 510, which in this implementation may comprise a cellular network.

At block 715, the image, sound, and/or video is provided via the cellular network to one or more premise management security devices. In an implementation, the premise security management device management engine 620 may provide the image, sound, and/or video to one or more of the premise security management device(s) 525. The image, sound, and/or video may pass, at least in part, through the first network 510. In various implementations, the premise security management device(s) 525 may display the image, sound, and/or video on an application (e.g., a native application or within a container application) to a user.

At block 720, the image, sound, and/or video is provided via the cellular network to an internal unit of one or more of the secure gatekeeper(s). In various implementations, the internal device management engine 615 provides the image, sound, and/or video to one of the internal device 505-1 of one or more of the secure gatekeeper(s) 505. The image, sound, and/or video may pass, at least in part, through the first network 510. In various implementations, the internal device 505-1 may display the image, sound, and/or video to a user.

At block 725, images, sound, and/or video are received via the cellular network, from the one or more premise security management device(s). In an implementation, the premise security management device management engine 620 receives images, sound, and/or video from the premise security management device(s) 525. The images, sound, and/or video may pass, at least in part, through the first network 510. At block 730, images, sound, and/or video are received via the cellular network, from the internal device. In an implementation, the internal device management engine 615 receives images, sound, and/or video from the internal device 505-1. The images, sound, and/or video may pass, at least in part, through the first network 510.

At block 735, the images, sound, and/or video from the premise security management device(s) and/or the images, sound, and/or video from the internal device are provided via the cellular network to the external device. In some implementations, the external device management engine 610 provides the images, sound, and/or video from the premise security management device(s) 525 and/or the images, sound, and/or video from the internal device 505-1 are provided via the cellular network to the external device 505-2. The images, sound, and/or video may pass, at least in part, through the first network 510.

At block 740, the external device is instructed, via the cellular network, to display the images, sound, and/or video from the premise security management device(s) and/or the images, sound, and/or video from the internal device. In an implementation, the external device management engine 610 instructs, at least partly through the first network 510, to display the images, sound, and/or video from the premise security management device(s) 525 and/or the images, sound, and/or video from the internal device 505-1.

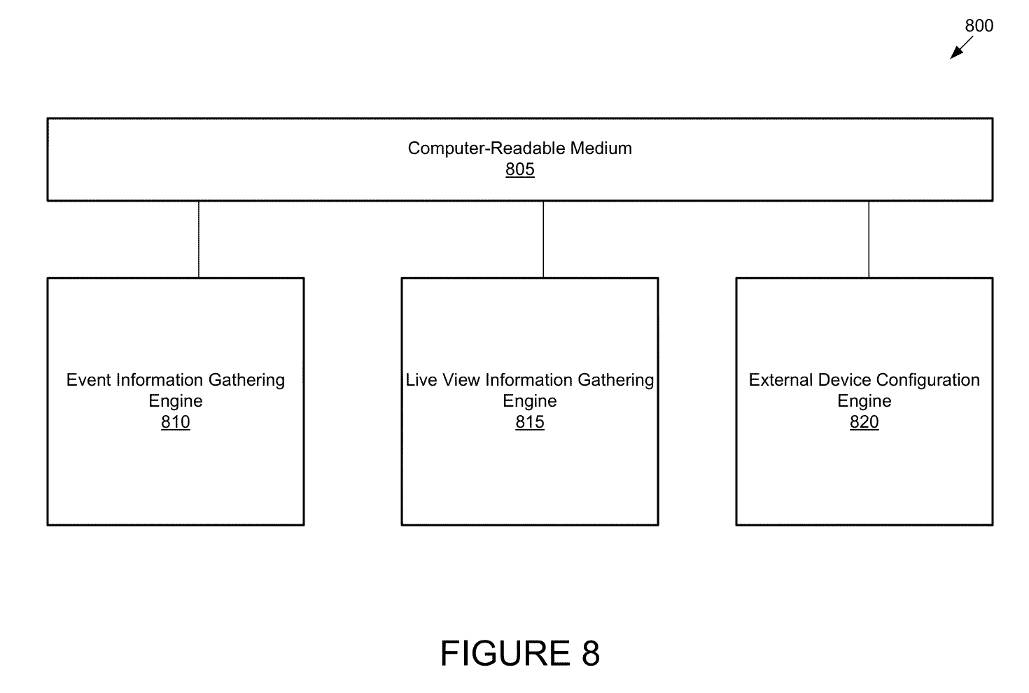

FIG. 8 depicts an example of an external device management engine 800. In the example of FIG. 8, the external device management engine 800 includes a computer-readable medium 805, an event information gathering engine 810, a live view information gathering engine 815, and an external device configuration engine 820. In an implementation, the computer-readable medium 805 includes a “computer-readable medium,” as discussed herein. In various implementations, one or more of the event information gathering engine 810, the live view information gathering engine 815, and the external device configuration engine 820 includes one or more “engines,” and/or “datastores,” as described herein.

In the example of FIG. 8, the event information gathering engine 810 is coupled to the computer-readable medium 805. In an implementation, the event information gathering engine 810 gathers events that have occurred on the external device 505-2. More specifically, the event information gathering engine 810 may be coupled to sensors (e.g., infrared and other motion sensors) and other components of the external device 505-2 that indicate a significant event, such as the presence of a person at the external device 505-2. The event information gathering engine 810 may also provide significant events to other engines. In some implementations, the event information gathering engine 810 provides notifications relating to events to other engines. In various implementations, the event information gathering engine 810 provides archived events of the external device 505-2.

In the example of FIG. 8, the live view information gathering engine 815 is coupled to the computer-readable medium 805. In various implementations, the live view information gathering engine 815 provides images, sounds, and/or video of events near the external device 505-2. In some implementations, the live view information gathering engine 815 interfaces with cameras, displays, microphones, and/or speakers on the external device 505-2. The live view information gathering engine 815 may, in various implementations, be triggered by significant events as determined by the event information gathering engine 810.

In the example of FIG. 8, the external device configuration engine 820 is coupled to the computer-readable medium 805. In an implementation, the external device configuration engine 820 configures the external device 505-2. More specifically, the external device configuration engine 820 may provide configuration parameters for portions of the external device 505-2. As an example, the external device configuration engine 820 may control camera parameters, such as making a camera on the external device 505-2 zoom, change perspective, focus, or capture an angle. The external device configuration engine 820 may also control microphones at various levels and/or directions, and/or may control speaker systems of the external device 505-2. In some implementations, the external device configuration engine 820 controls one or more other configuration parameters of the external device 505-2.

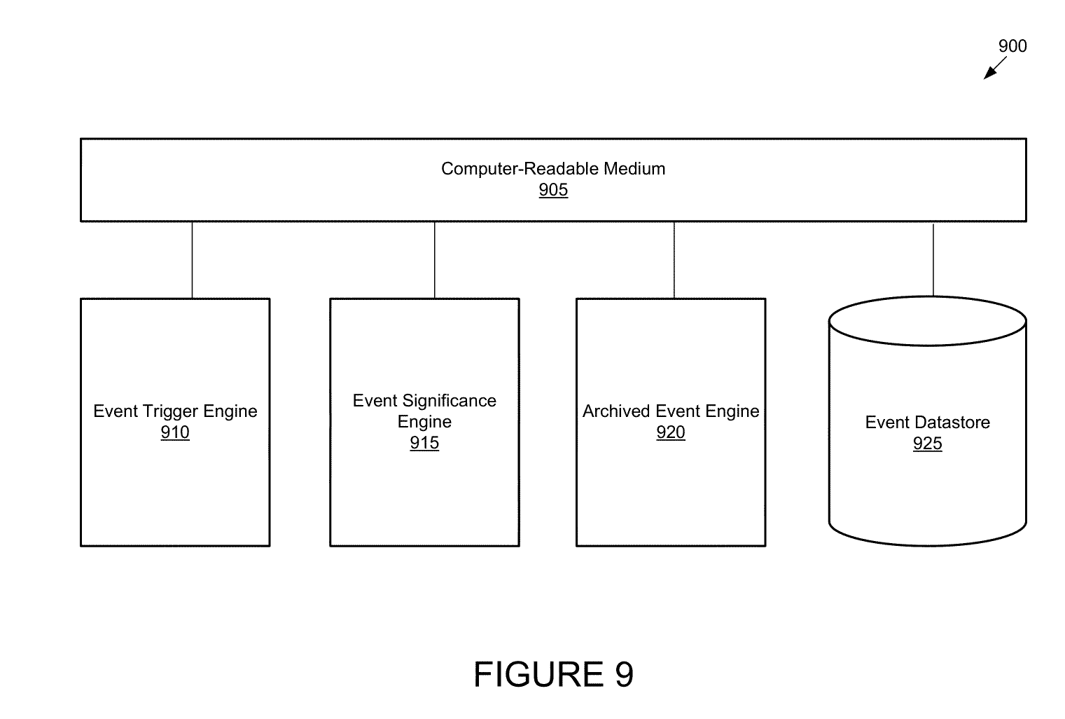

FIG. 9 depicts an example of an event information gathering engine 900. In the example of FIG. 9, the event information gathering engine 900 includes a computer-readable medium 905, an event trigger engine 910, an event significance engine 915, an archived event engine 920, and an event datastore 925. In an implementation, the computer-readable medium 905 includes a “computer-readable medium,” as discussed herein. In various implementations, one or more of the event trigger engine 910, the event significance engine 915, and the archived event engine 920 include one or more “engines,” as described herein. In an implementation, the event datastore 925 includes one or more “datastores,” as described herein.

In the example of FIG. 9, the event trigger engine 910 is coupled to the computer-readable medium 905. In an implementation, the event trigger engine 910 receives a set of event triggers from an external device (e.g., the external device 505-2 in FIG. 5). More specifically, the event trigger engine 910 may, in various implementations, interface with sensors on the external device. For instance, the event trigger engine 910 may interface with a motion sensor of the external device to determine a person is near or is moving near the external device. As another example, the event trigger engine 910 may interface with a heat sensor on the external device to determine a person is near or is moving near the external device. The event trigger engine 910 may also interface with other items, such as cameras, microphones, etc., to determine events near the external device.

In the example of FIG. 9, the event significance engine 915 is coupled to the computer-readable medium 905. In various implementations, the event significance engine 915 determines whether event triggers are sufficiently important to be characterized as significant. For example, in an implementation, the event significance engine 915 may determine whether the data from a motion sensor on the external device (e.g., the external device 505-2 in FIG. 5) is significant enough to qualify as human motion or is the motion of a non-human animal like a cat or raccoon. As another example, the event significance engine 915 may determine whether data from a heat sensor on the external device is significant enough to qualify as a fire near the external device, or merely reflects a hot day. In an implementation, the event significance engine 915 may base significance on similarity to an archived event stored on the event datastore 925.

In the example of FIG. 9, the archived event engine 920 is coupled to the computer-readable medium 905. In some implementations, the archived event engine 920 retrieves archived events from the event datastore 925. The event datastore 925, which in the example of FIG. 9 is coupled to the computer-readable medium 905, may, in various implementations, store archived events. The archived events may comprise events archived for a particular external device and may further comprise events archived for other external devices. In some implementations, the archived events may comprise hypothetical or ideal events that are stored for the purpose of determining event significance or other purposes.

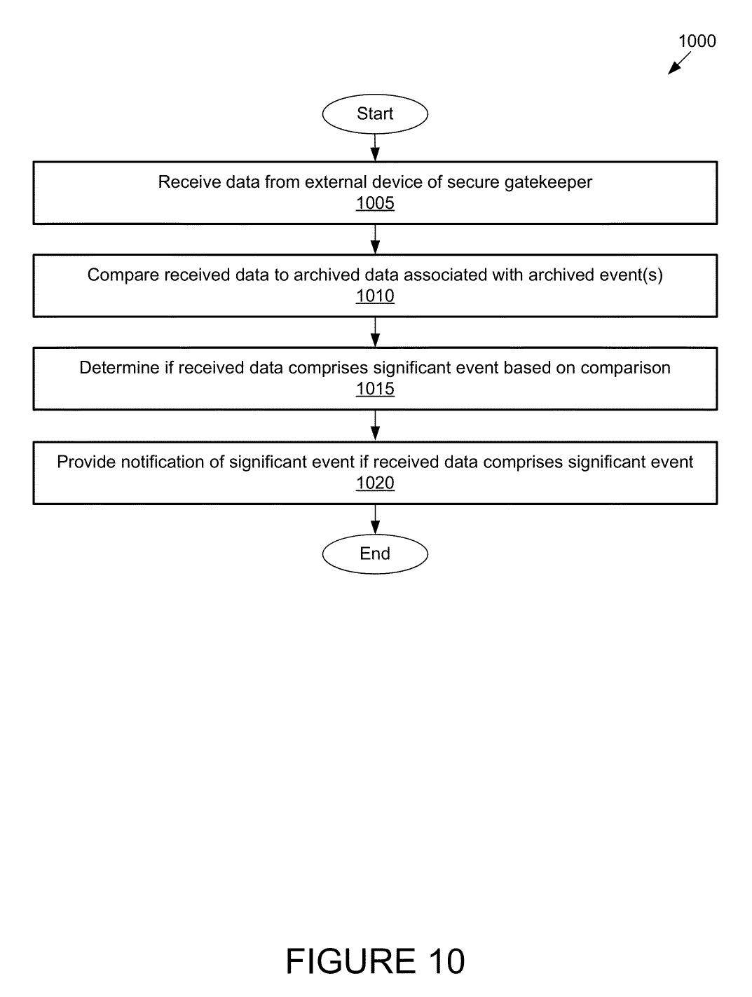

FIG. 10 depicts a flowchart 1000 of an example of a method for providing event information from an event information gathering engine. In an implementation, the flowchart 1000 is discussed in conjunction with the structures shown in FIG. 9. It is noted the flowchart 1000 may have additional, fewer, or other modules than those depicted in FIG. 10.

At block 1005, data from an external device of a secure gatekeeper is received. In an implementation, the event trigger engine 910 receives data from an external device (e.g., an external device 505-2) of one or more of the secure gatekeepers 505. The data may comprise data from a sensor (e.g., a motion sensor, a heat sensor, etc.) of the external device 505-2. In some implementations, the data is received over a cellular network, such as the first network 510.

At block 1010, the received data is compared to archived data associated with one or more archived events. In an implementation, the event significance engine 915 compares the received data to archived data. For instance, the event significance engine 915 can compare data from a motion sensor on the external device to motion-related data of archived events. As another example, the event significance engine 915 can compare heat captured from a heat sensor on the external device to heat-related data of archived events.

At block 1015, it is determined whether the received data comprises a significant event; the determination is based on the comparison. In an implementation, the event significance engine 915 can determine whether the received data comprises a significant event by evaluating the comparison. At block 1020, a notification of the significant event is provided if the received data comprises a significant event. In some implementations, the event significance engine 915 can provide such a notification.

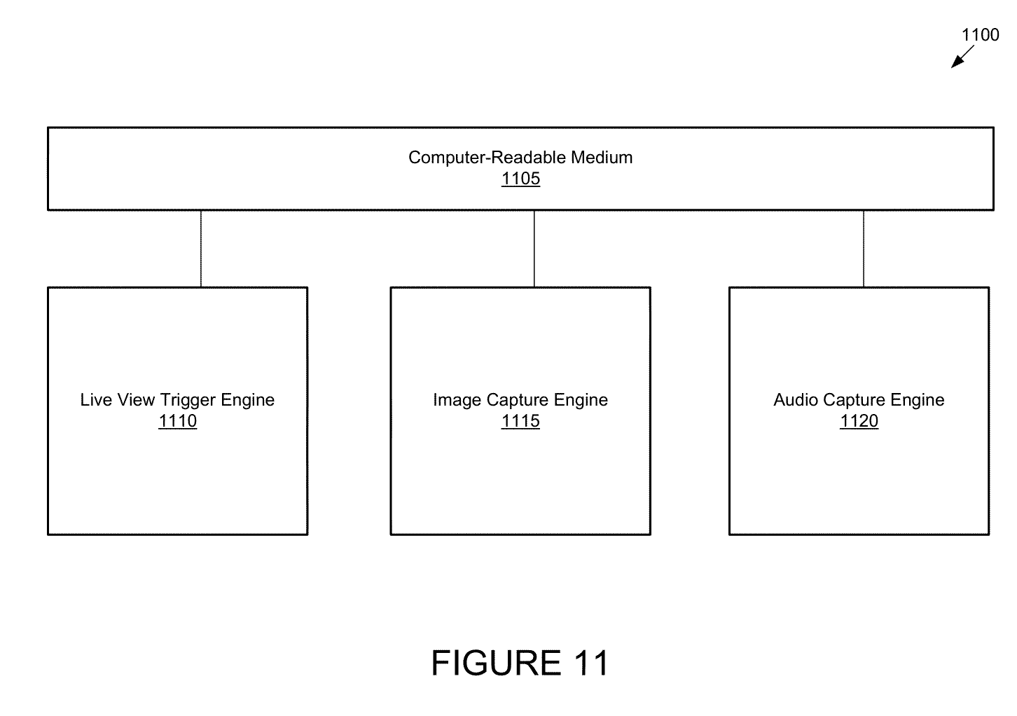

FIG. 11 depicts an example of a live view information gathering engine 1100. In the example of FIG. 11, the live view information gathering engine 1100 includes a computer-readable medium 1105, a live view trigger engine 1110, an image capture engine 1115, and an audio capture engine 1120. In an implementation, the computer-readable medium 1105 includes a “computer-readable medium,” as discussed herein. In various implementations, one or more of the live view trigger engine 1110, the image capture engine 1115, and the audio capture engine 1120 include one or more “engines” and/or “datastores,” as described herein.

In the example of FIG. 11, the live view trigger engine 1110 is coupled to the computer-readable medium 1105. In a specific implementation, the live view trigger engine 1110 receives live view triggers from an external device (e.g., the external device 505-2) of one or more secure gatekeepers (e.g., one or more of the secure gatekeepers 505). In some implementations, the live view trigger may result from a sensor, such as a motion sensor, a heat sensor, etc. being triggered. The live view trigger may also result from specific instructions from a premise security management device (e.g., one or more of the premise security management devices 525 in FIG. 5) to initiate a live view. The live view trigger may instruct other engines to initiate capture of images, sound, and/or video.

In the example of FIG. 11, the image capture engine 1115 is coupled to the computer-readable medium 1105. In an implementation, the image capture engine 1115 may direct cameras on an external device of a secure gatekeeper (e.g., an external device 505-2 of one or more of the secure gatekeepers 505) to capture images and/or video. In the example of FIG. 11, the audio capture engine 1120 is coupled to the computer-readable medium 1105. In an implementation, the audio capture engine 1120 may direct microphones on an external device of a secure gatekeeper (e.g., an external device 505-2 of one or more of the secure gatekeepers 505) to capture sound.

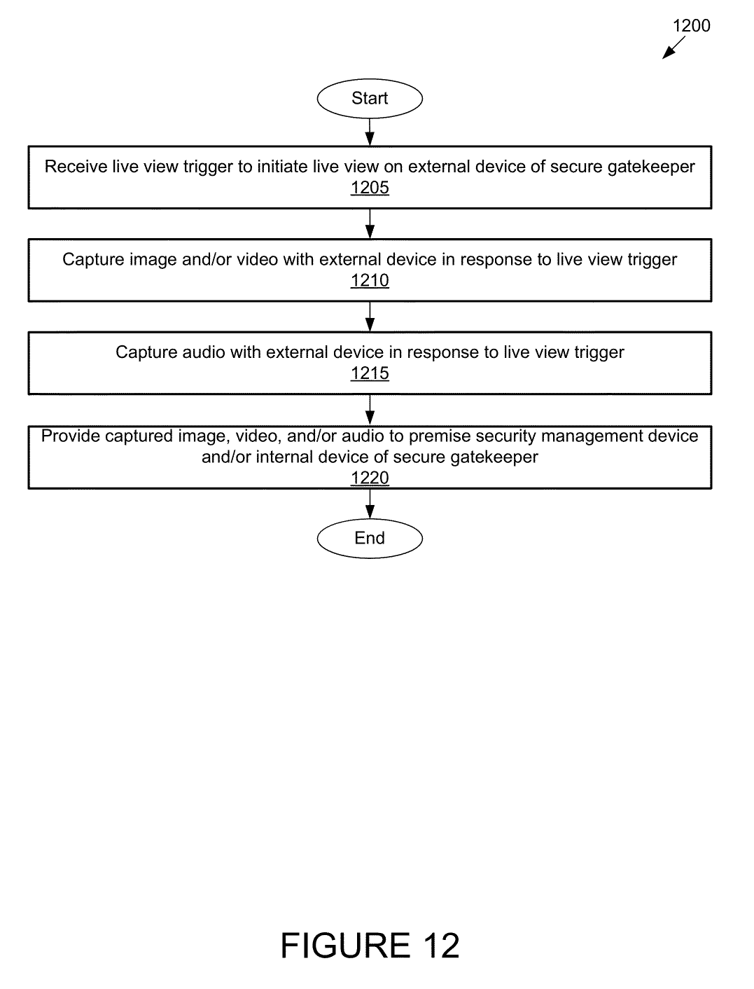

FIG. 12 depicts a flowchart 1200 of an example of a method for providing live view information related to a premise security management web portal system. In an implementation, the flowchart 1200 is discussed in conjunction with the structures shown in FIG. 11. It is noted the flowchart 1200 may have additional, fewer, or other modules than those depicted in FIG. 12.

At block 1205, a live view trigger is received; the live view trigger initiates a live view on an external device of a secure gatekeeper. In an implementation, the live view trigger engine 1110 can initiate a live view on the external device 505-2 of one of the secure gatekeepers 505, shown in FIG. 5. The live view trigger engine 1110 may initiate the live view based on information from a sensor, e.g., a motion sensor, a heat sensor, etc.

At block 1210, images and/or video are captured with the external device in response to the live view trigger. In an implementation, the image capture engine 1115 instructs a camera on the external device 505-2 to capture images and/or video of the area proximate to the external device 505-2. At block 1215, audio is captured with the external device in response to the live view trigger. In an implementation, the audio capture engine 1120 instructs a microphone on the external device 505-2 to capture audio of the area proximate to the external device 505-2. At block 1220, the captured images, video, and/or audio is provided to a premise security management device and/or an internal device of the secure gatekeeper. In implementations, the captured images, video, and/or audio may be provided to premise security management device(s) 525 and/or an internal device 505-1 of secure gatekeeper(s) 505.

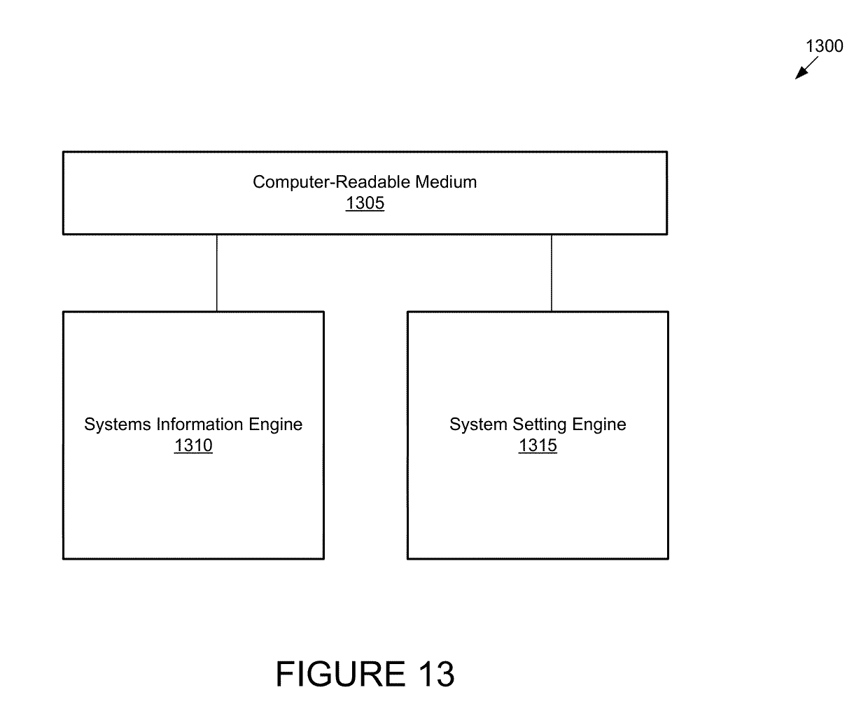

FIG. 13 depicts an example of an external device configuration engine 1300. In the example of FIG. 13, the external device configuration engine 1300 includes a computer-readable medium 1305, a system information engine 1310, and a system setting engine 1315. In an implementation, the computer-readable medium 1305 includes a “computer-readable medium,” as discussed herein. In various implementations, one or more of the system information engine 1310 and the system setting engine 1315 include one or more “engines” and/or “datastores,” as described herein.

In the example of FIG. 13, the system information engine 1310 is coupled to the computer-readable medium 1305. In an implementation, the system information engine 1310 is configured to obtain a present configuration of an external device. For instance, the system information engine 1310 may determine existing configuration parameters of cameras of the external device (e.g., zoom, perspective, focus, angle, etc. parameters). As another example, the system information engine 1310 may determine existing configuration parameters of microphones and/or speakers of the external device (e.g., sound levels, etc. parameters). In the example of FIG. 13, the system setting engine 1315 is coupled to the computer-readable medium 1305. In an implementation, the system setting engine 1315 allows setting relevant parameters on the external device.

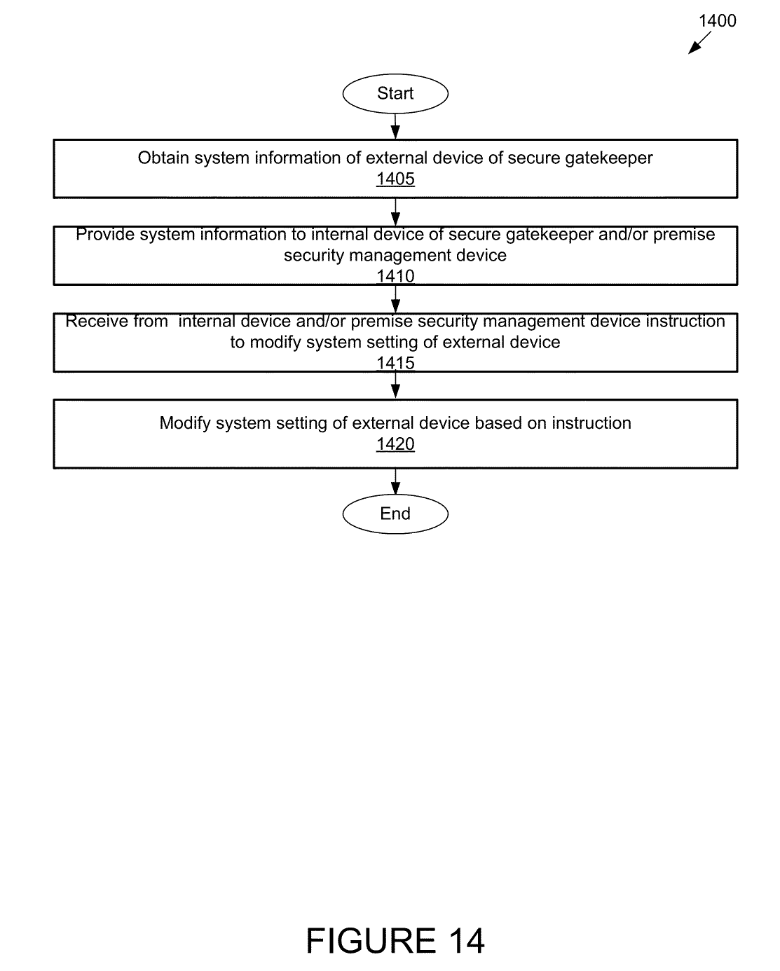

FIG. 14 depicts a flowchart 1400 of an example of a method for configuring an external device of a secure gatekeeper. In an implementation, the flowchart 1400 is discussed in conjunction with the structures shown in FIG. 13. It is noted the flowchart 1400 may have additional, fewer, or other modules than those depicted in FIG. 14.

At block 1405, system information of an external device of a secure gatekeeper is obtained. In an implementation, the system information engine 1310 obtains information of an external device of a secure gatekeeper (e.g., an external device 505-2 of one or more of the secure gatekeeper(s) 505). The system information may include, in various examples, camera settings, microphone settings, speaker settings, and/or other configuration parameters of the external device 505.

At block 1410, the system information is provided to an internal device of the secure gatekeeper and/or a premise security management device. In an implementation, an internal device management engine (e.g., the internal device management engine 615 in FIG. 6) may provide the system information to the internal device 505-1 (shown in FIG. 5) of one or more of the secure gatekeeper(s) 505. Further, in an implementation, a premise security management device management engine (e.g., the premise security management device management engine 620 of FIG. 6) may provide the system information to one or more of the premise security management devices 525 (shown in FIG. 5).

At block 1415, an instruction to modify a system setting of the external device is received from the internal device and/or the premise security management device. In some implementations, an internal device management engine (e.g., the internal device management engine 615 in FIG. 6) may provide to the system setting engine 1315 an instruction to modify a system setting of the external device. Similarly, in some implementations, a premise security management device management engine (e.g., the premise security management device management engine 620 of FIG. 6) may provide to the system setting engine 1315 an instruction to modify a system setting of the external device. In these implementations, the system setting engine 1315 receives an instruction to modify a system setting of the external device.

At block 1420, a system setting of the external device is modified based on the instruction. In implementations, the system setting engine 1315 may modify, e.g., camera parameters, microphone parameters, speaker parameters, etc. based on the instructions to modify the external device.

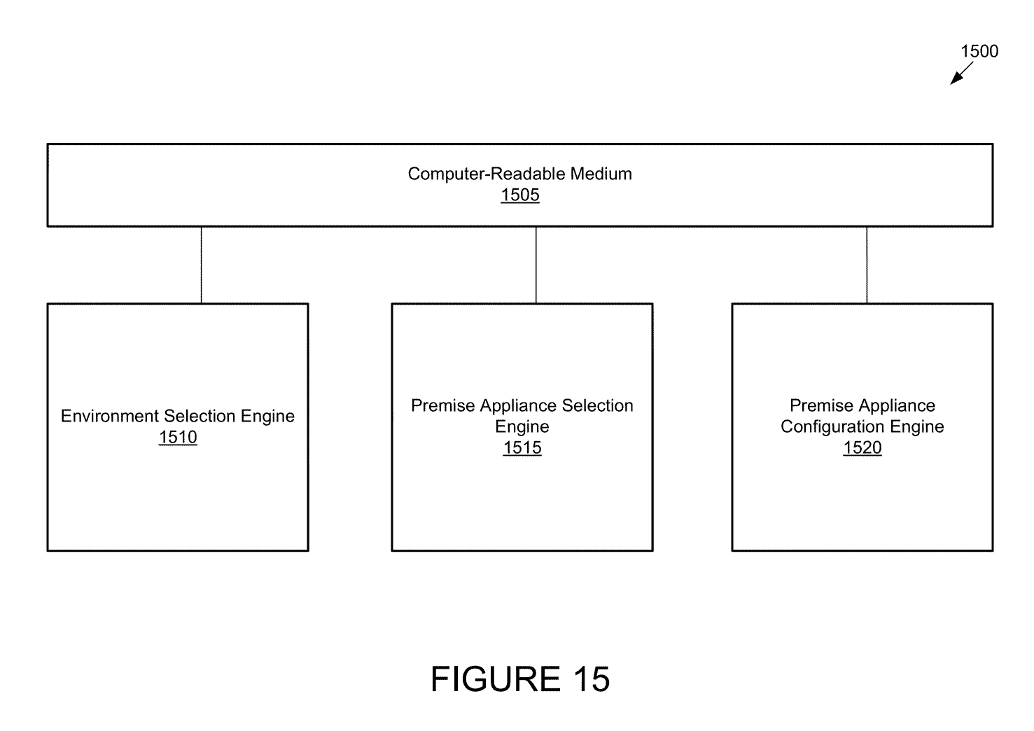

FIG. 15 depicts an example of a premise appliance management engine 1500. In the example of FIG. 15, the premise appliance management engine 1500 includes a computer-readable medium 1505, an environment selection engine 1510, a premise appliance selection engine 1515, and a premise appliance configuration engine 1520. In an implementation, the computer-readable medium 1505 includes a “computer-readable medium,” as discussed herein. In various implementations, one or more of the environment selection engine 1510, the premise appliance selection engine 1515, and the premise appliance configuration engine 1520 include one or more “engines” and/or “datastores,” as described herein.

In the example of FIG. 15, the environment selection engine 1510 is coupled to the computer-readable medium 1505. In an implementation, the environment selection engine 1510 allows for selection of an environment containing one or more premise appliances. For instance, the environment selection engine 1510 may allow for the selection of one or more rooms (e.g., bedroom, living room, kitchen, bathroom, etc.) of a premise containing premise appliances. It is noted environments need not be rooms, but may arbitrarily be any space in given premises. In the example of FIG. 15, the premise appliance selection engine 1515 is coupled to the computer-readable medium 1505. In a specific implementation, the premise appliance selection engine 1515 allows for the selection of particular appliances within an environment. For example, the premise appliance selection engine 1515 could allow a user to select lamps, ovens, heating or cooling systems, washers or dryers, dishwashers, refrigerators, etc. within a given environment. In the example of FIG. 15, the premise appliance configuration engine 1520 is coupled to the computer-readable medium 1505. In an implementation, the premise appliance configuration engine 1520 allows for configurations of selected appliances.

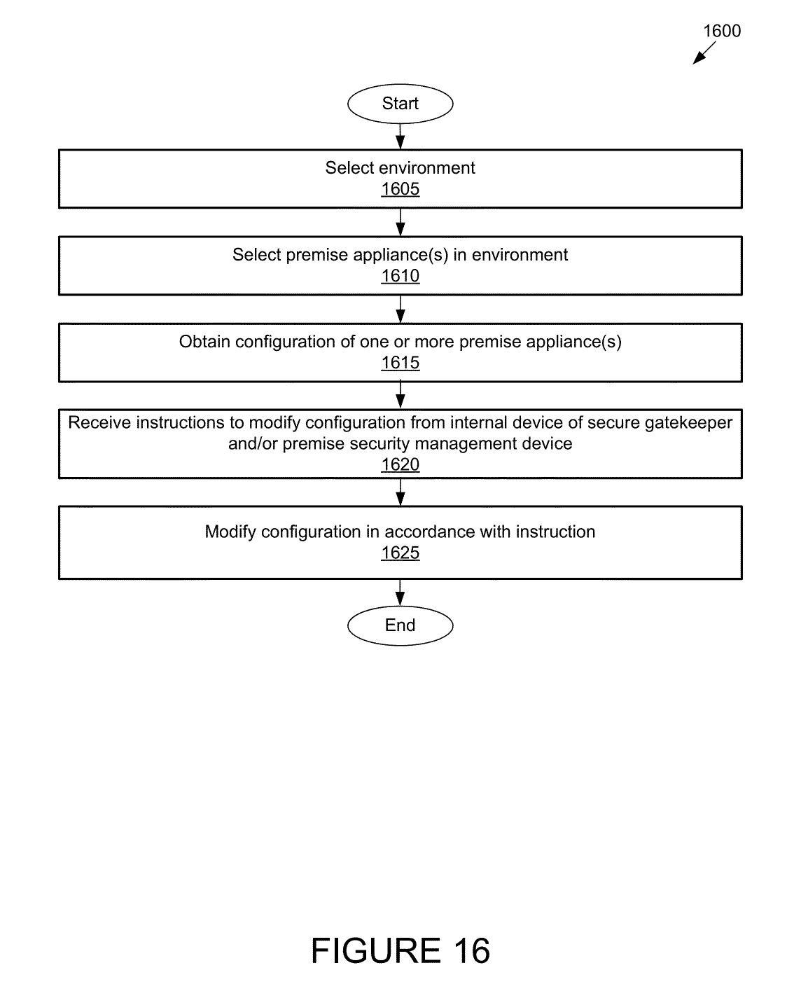

FIG. 16 depicts a flowchart 1600 of an example of a method for managing one or more premise appliances. In an implementation, the flowchart 1600 is discussed in conjunction with the structures shown in FIG. 15. It is noted the flowchart 1600 may have additional, fewer, or other modules than those depicted in FIG. 16.

At block 1605, an environment is selected. In a specific implementation, the environment selection engine 1510 facilitates selection of an environment comprising an arbitrary area within a set of premises. The environment may include one or more premise appliances, such as one or more of the premise appliances 530 shown in FIG. 5. At block 1610, premise appliance(s) in the environment are selected. In some implementations, the premise appliance selection engine 1515 allows selection of particular premise appliance(s) in the selected environment. At block 1615, a configuration of one or more of the selected premise appliance(s) is obtained. In some implementations, the premise appliance configuration engine 1520 may obtain the configuration of one or more of the selected premise appliances.

At block 1620, instructions to modify the configuration are received from an internal device of a secure gatekeeper and/or a premise security management device. In some implementations, the premise appliance configuration engine 1520 receives instructions to modify the configuration. The instructions may come from an internal device (e.g., an internal device 505-1 of one or more of the secure gatekeepers 505). The instructions may come from a premise security management device (e.g., one or more of the premise security management devices 525). At block 1625, the configuration is modified in accordance with the instruction. In an implementation, the premise appliance configuration engine 1520 may modify the configuration in accordance with the instruction.

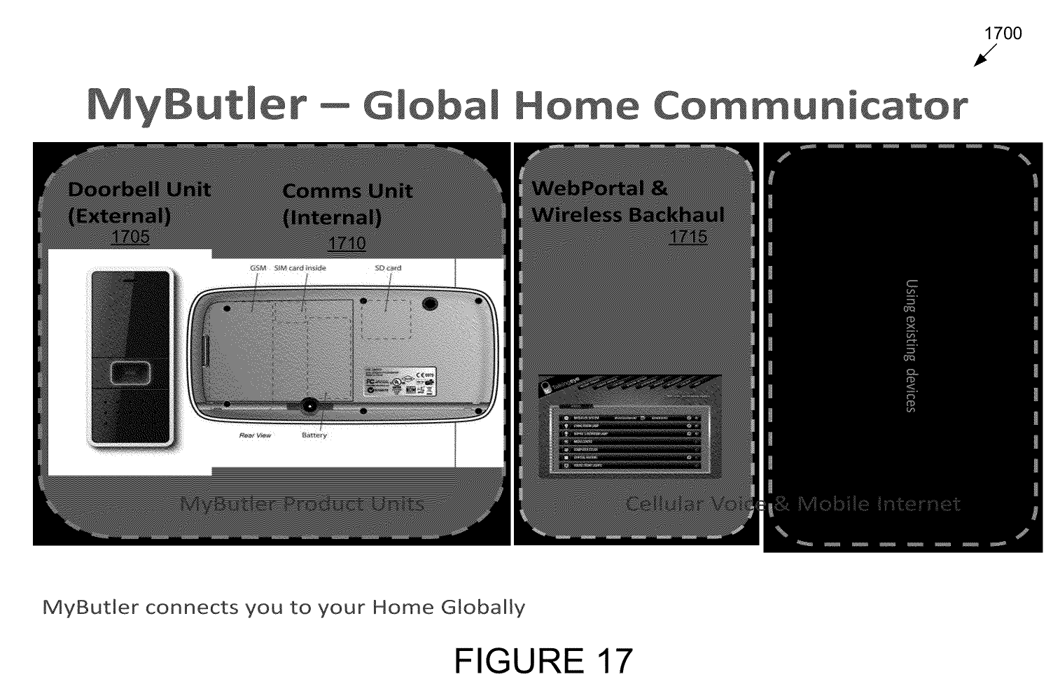

FIG. 17 depicts an example of a premise security management environment 1700. In the example of FIG. 17, the premise security management environment 1700 includes an external device 1705, an internal device 1710, a premise security web portal system 1715, and premise security management device(s) 1720. In the example of FIG. 17, the external device 1705 is coupled to the internal device 1710. In an implementation, the external device 1705 corresponds to one of the external device(s) 505-2, shown in FIG. 5. In various implementations, the external device 1705 can perform one or more of the following: providing two-way voice and/or cellular data over a cellular network; taking time(s)/date(s)/picture(s)/video(s) of people approaching the front of premises; logging entry and/or exit times; allowing occupants to safely talk to visitors while inside the premises; manually taking pictures of visitors; and providing anti-tamper and early warning alert systems.

In the example of FIG. 17, the internal device 1710 is coupled to the external device 1705 and to the premise security web portal system 1715. In an implementation, the internal device 1710 corresponds to one of the internal device(s) 505-1, shown in FIG. 5. In some implementations, the internal device 1710 has one or more of the following attributes: not being dependent on ADSL, routers, broadband connections, or PCs; not being disabled if a power line or telephone line is cut; enabling other home connected products using similar wireless communications; using data encryption techniques for secure network transmissions. In an implementation, the internal device 1710 has a display panel for occupants to see videos of visitors; the internal device 1710 can also provide menu displays for other connected devices.

In the example of FIG. 17, the premise security web portal system 1715 is coupled to the internal device 1710 and the premise security management device 1720. In an implementation, the premise security web portal system 1715 corresponds to the premise security web portal system 520, shown in FIG. 5.

In the example of FIG. 17, the premise security management device 1720 is coupled to the premise security web portal system 1715. In the example of FIG. 17, the premise security management device(s) 1720 include a web-enabled premise security management device 1720a and a native premise security management device 1720b. Either of the web-enabled premise security management device 1720a and the native premise security management device 1720b can be configured to perform the functions herein. In some implementations, the premise security management device 1720 corresponds to the one or more of the premise security management device(s) 525, shown in FIG. 5. In various implementations, the premise security management device 1720 performs one or more of the following: answering calls; controlling the external device 1705 and/or internal device 1710 remotely; controlling the premise security web portal system 1715 remotely; turning on or off appliances; viewing closed circuit television (CCTV) for the external device 1705; turning power on or off; switching lighting on or off; seeing who has visited the premises; open and/or locking a parcel box; locking and/or unlocking a porch door; resetting a profile of the premises; and managing account settings.

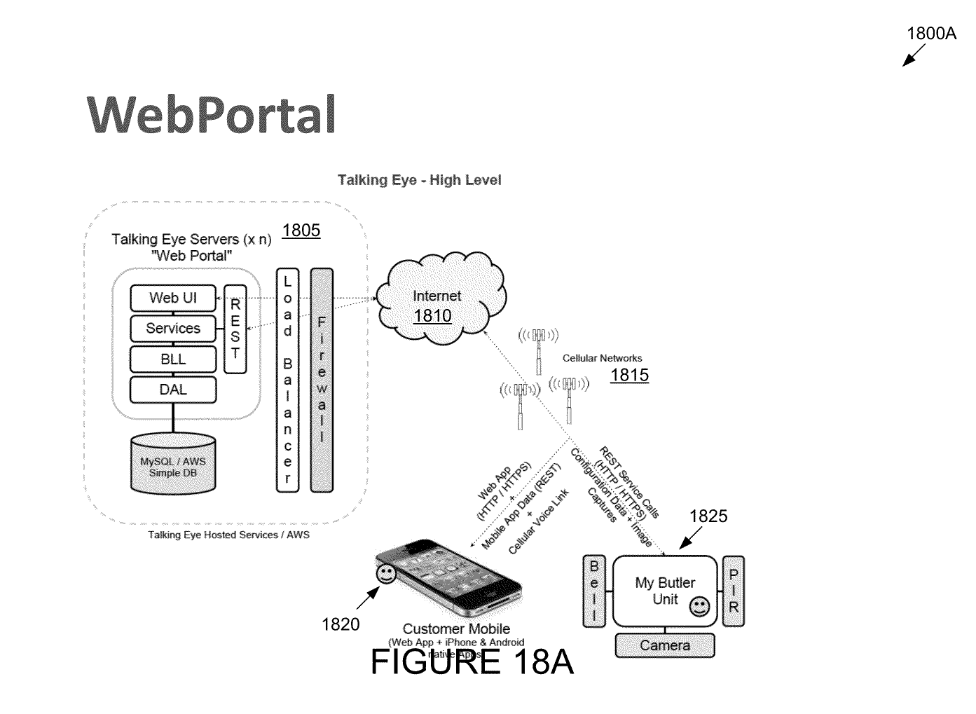

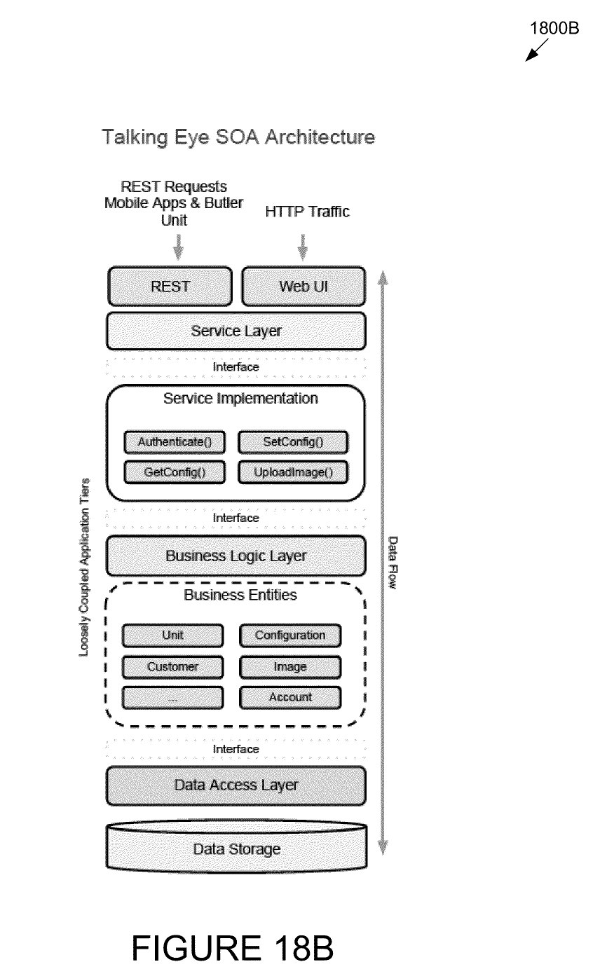

FIG. 18A depicts an example of a premise security management environment 1800. In the example of FIG. 18A, the premise security management environment 1800 includes a premise security web portal system 1805, an Internet 1810, a set of cellular networks 1815, a premise security management device 1820, and a secure gatekeeper 1825. In the example of FIG. 18A, the premise security web portal system 1805 is coupled to the Internet 1810. In a specific implementation, the premise security web portal system 1805 is coupled to the Internet 1810 through a firewall and a load balancer. The premise security web portal system 1805 can include a web user interface (UI) module, a representational state transfer (REST) module, a services module, a Business Logic Layer (BLL), a Data Access Layer (DAL), a data storage datastore, and other modules. In an implementation, the premise security web portal system 1805 corresponds to the premise security web portal system 520, shown in FIG. 5.

In the example of FIG. 18A, the Internet 1810 is coupled to the premise security web portal system 1805, the premise security management device 1820, and the secure gatekeeper 1825. In an implementation, the Internet 1810 can correspond to the second network 515, shown in FIG. 5.

In the example of FIG. 18A, the set of cellular networks 1815 is coupled to the Internet 1810, the premise security management device 1820, and to the secure gatekeeper 1825. In an implementation, the set of cellular networks 1815 may correspond to the second network 515, shown in FIG. 5.

In the example of FIG. 18A, the premise security management device 1820 is coupled to the set of cellular networks 1815. In an implementation, the coupling of the premise security management device 1820 to the set of cellular networks 1815 is accomplished through mobile application data (e.g., representational state transfer) and/or through a cellular voice link. The coupling of the premise security management device 1820 to the set of cellular networks 1815 may also be accomplished through a web application, such as a secure web application using secure hypertext transfer protocols (HTTPS) and/or other protocols. The coupling of the premise security management device 1820 to the set of cellular networks 1815 may also be accomplished through native mobile applications. In some implementations, the premise security management device 1820 corresponds to one or more of the premise security management device(s) 525, shown in FIG. 5.

In the example of FIG. 18A, the secure gatekeeper 1825 is coupled to the set of cellular networks 1815. In the example of FIG. 18A, the secure gatekeeper 1825 includes a bell unit, a “MyButler” control unit, a camera unit, and a passive infrared (PIR) unit. In some implementations, the bell unit may correspond to an external portion of the secure gatekeeper 1825, while the control unit may correspond to an internal portion of the secure gatekeeper 1825.

In various implementations, the coupling of the secure gatekeeper 1825 to the set of cellular networks 1815 is accomplished through representational state transfer calls using connections, such as HTTPS and/or other protocols. In various implementations, the secure gatekeeper 1825 provides and/or receives configuration data, images, video, and/or sound to the premise security web portal system 1805. In various implementations, the secure gatekeeper 1825 may correspond to one or more of the secure gatekeeper(s) 505, shown in FIG. 5.

FIG. 18B depicts an example of an architecture 1800B used to implement the premise security web portal system 1805, shown in FIG. 18A. The architecture 1800B may include a representational state transfer (REST) module, a web user interface (UI) module, a service layer, a service implementation, a business logic layer, business entities, a data access layer, and a data storage datastore.

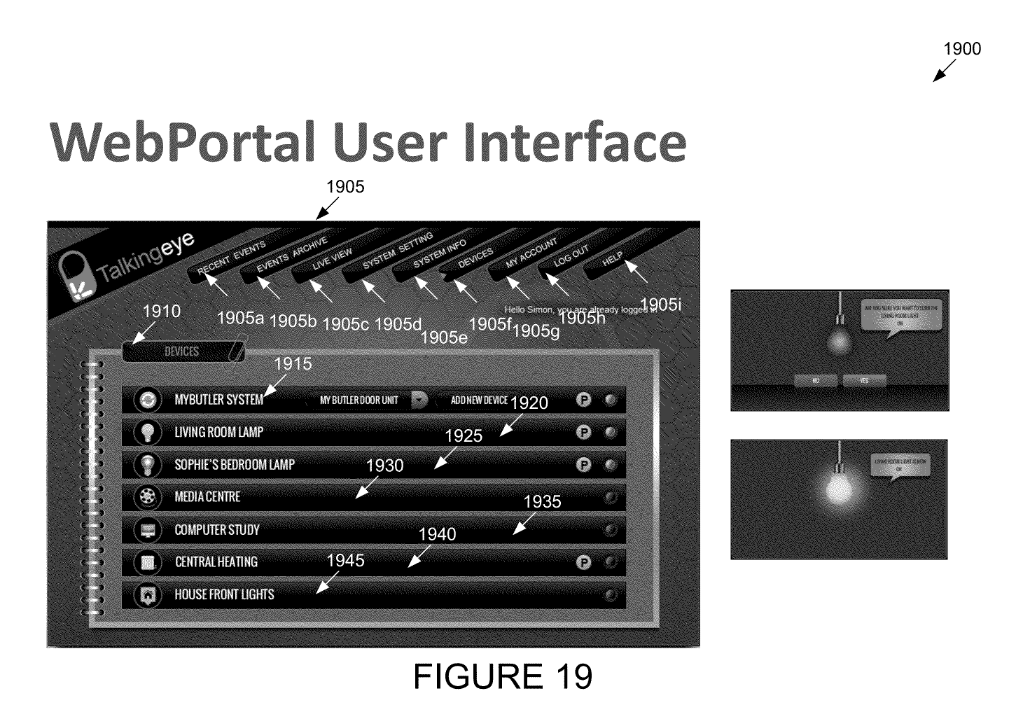

FIG. 19 depicts an example of a screen 1900 of a premise security web portal system. In an implementation, the screen 1900 may be displayed as a web page on the premise security management device(s) 525 based on content provided by the premise security web portal system 520, both shown in FIG. 5. In a specific implementation, the screen 1900 may display a web page to control the secure gatekeeper (s) 505, shown in FIG. 5.

In the example of FIG. 19, the screen 1900 includes buttons 1905 and a device list 1910. In the example of FIG. 19, the buttons 1905 include a recent events button 1905a, an events archive button 1905b, a live view button 1905c, a system settings button 1905d, a system information button 1905e, a device listing button 1905f, an account button 1905g, a log out button 1905h, and a help button 1905i. In an implementation, the recent events button 1905a links the user to a list of recent events associated with the secure gatekeeper(s) 505. In various implementations, the recent events button 1905a provides a list of recent events obtained using the event information gathering engine 810, shown in FIG. 8. In implementation, the events archive button 1905b links the user to a list of archived events. In some implementations, the events archive button 1905b provides a list of archived events obtained using the event information gathering engine 810, shown in FIG. 8.

In implementation, the live view button 1905c links the user to a live view of the premises. In various implementations, the live view button 1905c provides video, picture and//or sound from the live view information gathering engine 815, shown in FIG. 8. The video, picture and/or sound provided live view button 1905c may be based on the camera lens (9) and/or the microphone (49), shown in FIG. 1.

In implementation, the system settings button 1905d links the user to system settings related to the premise security web portal system 520, shown in FIG. 5. In various implementations, the settings provided by the system settings button 1905d may be based on the system setting engine 1315, shown in FIG. 13. In implementation, the system information button 1905e links the user to system information related to the premise security web portal system 520, shown in FIG. 5. In some implementations, system information provided by the system information button 1905e may be based on information from the system information engine 1310.

In implementation, the device listing button 1905f lists devices being monitored by the premise security web portal system 520. More specifically, in various implementations, the device listing button 1905f may list one or more of the secure gatekeeper(s) 505, shown in FIG. 5. In the example of FIG. 19, the device listing button 1905f has been selected, and various secure gatekeeper(s) 505, as well as other devices, as discussed herein, are listed.

In implementation, the account button 1905g links the user to the user's account information. The account button 1905g may provide information using the user account engine 830, shown in FIG. 8.

In the example of FIG. 19, the screen 1900 includes a device listing 1910. In various implementations, the device listing 1910 is provided once the user has selected the device listing button 1905f. In implementation, the log out button 1905h allows the user to log out of the premise security web portal system 520. In implementation, the help button 1905i links the user to help topics related to the premise security web portal system 520.

In the example of FIG. 19, the device listing 1910 includes a secure gatekeeper listing 1915, a living room lamp control 1920, a bedroom lamp control 1925, a media center control 1930, a computer study control 1935, a heating control 1940, and a front light control 1945. In various implementations, the user may be linked to the device listing 1910 after selecting the device listing button 1905f. In an implementation, the secure gatekeeper listing 1915 provides a listing of the secure gatekeeper(s) 505, shown in FIG. 5. The secure gatekeeper 1915 can provide the user with the ability to manage existing secure gatekeeper(s) and/or add new secure gatekeeper(s). In an implementation, the living room lamp control 1920 provides control of a living room lamp. In an implementation, the living room lamp being controlled by the living room lamp control 1920 may include one or more of the premise appliance(s) 530, shown in FIG. 5. In various implementations, the bedroom lamp control 1925 provides control of a bedroom lamp. In an implementation, the bedroom room lamp being controlled by the bedroom lamp control 1925 may include one or more of the premise appliance(s) 530, shown in FIG. 5. In an implementation, the media center control 1930 provides control of a media center. The media center may comprise one or more of the premise appliance(s) 530, shown in FIG. 5. In various implementations, the computer study control 1935 controls a computer study. The computer study may comprise one or more of the premise appliance(s) 530, shown in FIG. 5. In some implementations, the heating control 1940 controls a heating system of the premises. The heating system may comprise one or more of the premise appliance(s) 530, shown in FIG. 5. In various implementations, the front light control 1945 controls a front light of the premises. The front lights may comprise one more of the premise appliance(s), shown in FIG. 5.

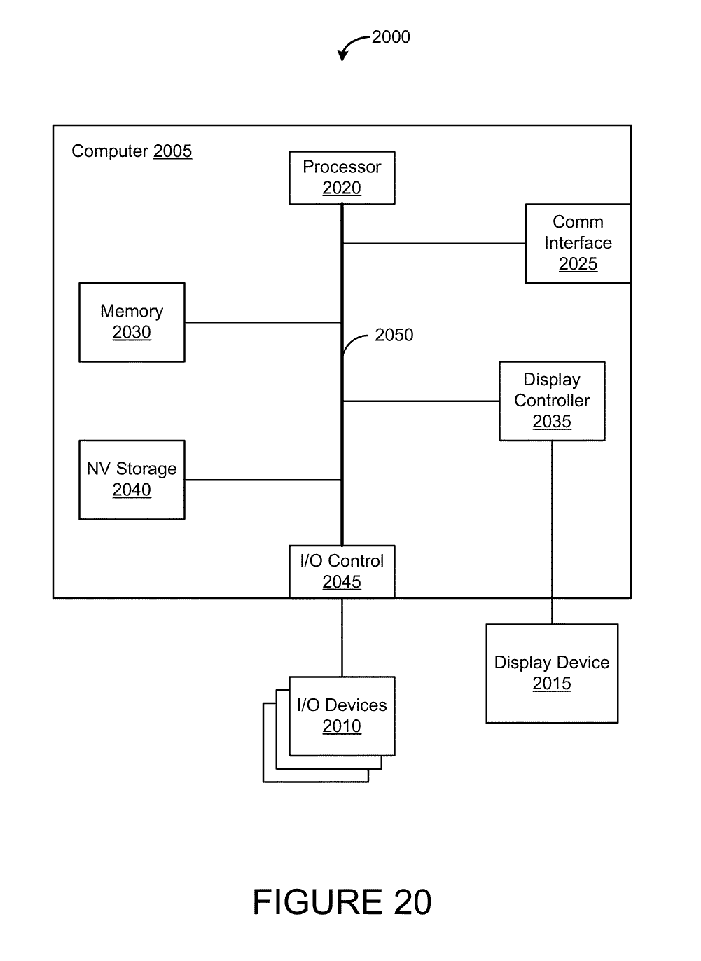

FIG. 20 shows an example of a computer system 2000 on which techniques described in this paper can be implemented. The computer system 2000 can be a conventional computer system that can be used as a client computer system, such as a wireless client or a workstation, or a server computer system. The computer system 2000 includes a computer 2005, I/O devices 2010, and a display device 2015. The computer 2005 includes a processor 2020, a communications interface 2025, memory 2030, a display controller 2035, non-volatile storage 2040, I/O controller 2045, and a bus 2050. The computer 2005 may be coupled to or include the I/O devices 2010 and display device 2015.

The computer 2005 interfaces to external systems through the communications interface 2025, which may include a modem or network interface. It will be appreciated that the communications interface 2025 can be considered to be part of the computer system 2000 or a part of the computer 2005. The communications interface 2025 can be an analog modem, ISDN modem, cable modem, token ring interface, satellite transmission interface (e.g. “direct PC”), or other interfaces for coupling a computer system to other computer systems.

The processor 2020 may be, for example, a conventional microprocessor such as an Intel Pentium microprocessor or Motorola power PC microprocessor. The memory 2030 is coupled to the processor 2020 by a bus 2050. The memory 2030 can be Dynamic Random Access Memory (DRAM) and can also include Static RAM (SRAM). The bus 2050 couples the processor 2020 to the memory 2030, also to the non-volatile storage 2040, to the display controller 2035, and to the I/O controller 2045.

The I/O devices 2010 can include a keyboard, disk drives, printers, a scanner, and other input and output devices, including a mouse or other pointing device. The display controller 2035 may control in the conventional manner a display on the display device 2015, which can be, for example, a cathode ray tube (CRT) or liquid crystal display (LCD). The display controller 2035 and the I/O controller 2045 can be implemented with conventional well-known technology.

The non-volatile storage 2040 is often a magnetic hard disk, an optical disk, or another form of storage for large amounts of data. Some of this data is often written, by a direct memory access process, into memory 2030 during execution of software in the computer 2005. One of skill in the art will immediately recognize that the terms “machine-readable medium” or “computer-readable medium” includes any type of storage device that is accessible by the processor 2020 and also encompasses a carrier wave that encodes a data signal.

The computer system 2000 is one example of many possible computer systems that have different architectures. For example, personal computers based on an Intel microprocessor often have multiple buses, one of which can be an I/O bus for the peripherals and one that directly connects the processor 2020 and the memory 2030 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 2030 for execution by the processor 2020. A Web TV system, which is known in the art, is also considered to be a computer system, but it may lack some of the features shown in FIG. 20, such as certain input or output devices. A typical computer system will usually include at least a processor, memory, and a bus coupling the memory to the processor.

Though FIG. 20 shows an example of the computer system 2000, it is noted that the term “computer system,” as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 20.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

What is claimed is:

1. A method comprising:
receiving, over a first network, premise data of a security event, the premise data captured by a secure gatekeeper, and the secure gatekeeper adapted to monitor premises;
receiving, over the first network, media adapted for display on the secure gatekeeper;
providing, over the first network, the media to the secure gatekeeper;
instructing, over the first network, the secure gatekeeper to display the media.

2. The method of claim 1, wherein:
the secure gatekeeper comprises an internal device coupled to the first network, and an external device coupled to the first network, the internal device located in a secure area of the premises, and the external device located in an unsecure area of the premises;
the external device is adapted to capture the premise data of the security event.

3. The method of claim 2, wherein the internal device is configured to capture the media adapted for display on the secure gatekeeper.

4. The method of claim 1, wherein a computer system coupled to the first network is configured to capture the media adapted for display on the secure gatekeeper.

5. The method of claim 4, wherein the media is captured on a web browser of the computer system.

6. The method of claim 4, wherein the media is captured on a native application of the computer system.

7. The method of claim 4, wherein the media is captured on a native application of the computer system, and the computer system comprises a mobile device.

8. The method of claim 1, wherein the media comprises one or more images, one or more sounds, or one or more videos of a person managing the premises.

9. The method of claim 1, wherein the media comprises a live stream of images, one or more sounds, or one or more videos of a person managing the premises.

10. The method of claim 9, wherein the live stream is captured on a web browser of a mobile device.

11. The method of claim 9, wherein the live stream is captured on a native application of a mobile device.

12. The method of claim 9, wherein the live stream is captured on an internal device of the secure gatekeeper, the internal device located in a secure area of the premises.

13. The method of claim 1, wherein the secure gatekeeper is integrated into an Intercom system coupled to the first network.

14. The method of claim 13, wherein the secure gatekeeper comprises a doorbell, a control engine, a camera, and an Infrared sensor.

15. The method of claim 1, wherein the first network comprises a cellular network.

16. The method of claim 15, wherein the cellular network provides cellular data and a cellular voice link to the secure gatekeeper.

17. The method of claim 1, wherein the security event comprises a moving object near the secure gatekeeper.

18. The method of claim 17, wherein the moving object comprises a person.

19. The method of claim 1, further comprising:
receiving, over the first network, a notification of the security event from the secure gatekeeper;
instructing the secure gatekeeper to capture the premise data, the instructing being in response to the notification of the security event.

20. The method of claim 19, wherein the notification comprises a signal indicating a moving object, the signal being from a motion sensor on the secure gatekeeper.

21. The method of claim 19, wherein the notification comprises a signal indicating a moving object, the signal being from a heat sensor on the secure gatekeeper.

22. The method of claim 1, further comprising:
receiving, over the first network, instructions to manage the secure gatekeeper;
managing the secure gatekeeper in accordance with the instructions.

23. The method of claim 1, further comprising:
receiving, over the first network, instructions to manage a premise appliance;
managing the premise appliance in accordance with the instructions.

24. A system comprising:
means for receiving, over a first network, premise data of a security event, the premise data captured by a secure gatekeeper, and the secure gatekeeper adapted to monitor premises;
means for receiving, over the first network, media adapted for display on the secure gatekeeper;
means for providing, over the first network, the media to the secure gatekeeper;
means for instructing, over the first network, the secure gatekeeper to display the media.

25. A system comprising:
an external device management engine coupled to a first network;
a premise security management device management engine coupled to the first network;
wherein, in operation:
premise security management device management engine receives, over the first network, media adapted for display on a secure gatekeeper;
the external device management engine:
receives, over the first network, premise data of a security event, the premise data captured by a secure gatekeeper, and the secure gatekeeper adapted to monitor premises;
provides, over the first network, the media to the secure gatekeeper;
instructs, over the first network, the secure gatekeeper to display the media.

26. The system of claim 25, wherein:
the secure gatekeeper comprises an internal device coupled to the first network, and an external device coupled to the first network, the internal device located in a secure area of the premises, and the external device located in an unsecure area of the premises;
the external device is adapted to capture the premise data of the security event.

27. The system of claim 26, wherein the internal device is configured to capture the media adapted for display on the secure gatekeeper.

28. The system of claim 25, wherein a computer system coupled to the first network is configured to capture the media adapted for display on the secure gatekeeper.

29. The system of claim 28, wherein the media is captured on a web browser of the computer system.

30. The system of claim 28, wherein the media is captured on a native application of the computer system.

31. The system of claim 28, wherein the media is captured on a native application of the computer system, and the computer system comprises a mobile device.

32. The system of claim 25, wherein the media comprises one or more images, one or more sounds, or one or more videos of a person managing the premises.

33. The system of claim 25, wherein the media comprises a live stream of images, one or more sounds, or one or more videos of a person managing the premises.

34. The system of claim 33, wherein the live stream is captured on a web browser of a mobile device.

35. The system of claim 33, wherein the live stream is captured on a native application of a mobile device.

36. The system of claim 33, wherein the live stream is captured on an internal device of the secure gatekeeper, the internal device located in a secure area of the premises.

37. The system of claim 25, wherein the secure gatekeeper is integrated into an Intercom system coupled to the first network.

38. The system of claim 37, wherein the secure gatekeeper comprises a doorbell, a control engine, a camera, and an Infrared sensor.

39. The system of claim 25, wherein the first network comprises a cellular network.

40. The system of claim 39, wherein the cellular network provides cellular data and a cellular voice link to the secure gatekeeper.

41. The system of claim 25, wherein the security event comprises a moving object near the secure gatekeeper.

42. The system of claim 41, wherein the moving object comprises a person.

43. The system of claim 25, wherein:
the external device management engine comprises an event information gathering engine and an external device configuration engine;
in operation:
the external device management engine receives, over the first network, a notification of the security event from the secure gatekeeper;
the external device configuration engine instructs the secure gatekeeper to capture the premise data, the instructing being in response to the notification of the security event.

44. The system of claim 43, wherein the notification comprises a signal indicating a moving object, the signal being from a motion sensor on the secure gatekeeper.

45. The system of claim 43, wherein the notification comprises a signal indicating a moving object, the signal being from a heat sensor on the secure gatekeeper.

46. The system of claim 25, wherein, in operation the external device management engine:
receives, over the first network, instructions to manage the secure gatekeeper;
manages the secure gatekeeper in accordance with the instructions.

47. The system of claim 25, further comprising a premise appliance management engine, wherein in operation, the premise appliance management engine:
receives, over the first network, instructions to manage a premise appliance;
manages the premise appliance in accordance with the instructions.
